(19) United States
(12) Patent Application Publication
(10) Pub. No.: US 2025/0170538 A1
(43) Pub. Date: May 29, 2025

(54) DYNAMIC MIXER FOR MULTIPLE COMPONENT APPLICATOR

(71) Applicant: Atlas Copco IAS GmbH, Bretten (DE)

(72) Inventors: Gerrit ENDERLE, Knittlingen (DE); Andreas HOIBL, Pentling (DE)

(21) Appl. No.: 18/959,523

(22) Filed: Nov. 25, 2024

(30) Foreign Application Priority Data
Nov. 28, 2023 (DE) 10 2023 133 272.4

(51) Int. Cl. B01F 25/31; B01F 23/20; B01F 23/235; B01F 27/192; B01F 27/806; B01F 35/21; B01F 35/221; B01F 35/30; B01F 35/32; B01F 35/50; B01F 101/00; H01M 10/658

(52) U.S. Cl. CPC B01F 25/31113; B01F 23/2351; B01F 23/291; B01F 27/192; B01F 27/806; B01F 35/2113; B01F 35/2217; B01F 35/2218; B01F 35/3204; B01F 35/54; B01F 2035/3513; B01F 2101/2805; H01M 10/658

(57) ABSTRACT

The present disclosure relates to an application apparatus for mixing a plurality of components for producing a multicomponent mixture, in particular a polyurethane foam, and for introducing and/or applying the multicomponent mixture into and/or onto an object, in particular a lithium-ion battery, comprising: a mixing tube having a first closed end and a second end for discharging the multicomponent mixture from the mixing tube, wherein the mixing tube has a mixing space, a plurality of injection units arranged on the mixing tube, each configured to inject one of the plurality of components into the mixing space, a mixer arranged in the mixing space, configured to mix the injected components with one another, and a moving device configured to move the mixer between the first end and the second end. Furthermore, an application system comprising the application apparatus and a method for mixing a plurality of components for producing a multicomponent mixture and for introducing and/or applying the multicomponent mixture into and/or onto an object is disclosed.

### CROSS-REFERENCE TO RELATED APPLICATIONS

This application claims priority to German Patent Application No. 10 2023 133 272.4, filed on Nov. 27, 2023, which is incorporated by reference herein in its entirety.

### Background

The invention relates to an application device for producing a multicomponent mixture, in particular a polyurethane foam, and for introducing/applying the multicomponent mixture into/onto an object, in particular during battery production, e.g. lithium-ion batteries. The invention further relates to an application system comprising the application device.

In the production of foams, one or more components are mixed with air, for example. Here, precise, reproducible and uniform mixing of the component itself and of the component with air is important. This includes the fact that the mass or volume ratio of the components to one another, and in particular to the air, in the foam can be set precisely to an optimum value and must be maintained continuously during the entire production of the foam. In addition, the mixture must be homogeneous in the entire foam volume. The foam must be able to be produced reproducibly over a plurality of production batches.

Poorly combustible foams are used for fire protection, for example in the case of batteries, and for insulation in the construction sector. Fire protection also plays an important role in the insulation. Here, the specified specifications for foam production are particularly important.

Lithium-based batteries, in particular lithium-ion batteries, are used, for example, for electric vehicles. Particularly frequently, such lithium-ion batteries are used for storing energy which has been generated using PV systems. However, lithium-ion batteries are also used in many other sectors for storing energy, in particular since their durability is very long. However, the use of lithium-ion batteries is not without problems.

Fire protection plays an extremely important role in the case of lithium-ion batteries, since lithium-ion batteries have a very destructive fire behavior and are difficult to extinguish. For preventive fire protection in the case of lithium-ion batteries, there are currently few practicable and/or only inadequately functioning solutions. These solutions include the application of fire protection material to a cover or housing of the battery, the provision of a honeycomb structure in the battery or the complete pouring out of the battery or of the battery cells of the battery.

A new type of fire protection is the use of polyurethane (“PU” for short) foams. For this purpose, the battery is foamed with a PU foam. In this case, the battery cells are surrounded with PU foam. If a defective battery cell burns or becomes thermally uncontrollable, the PU foam absorbs the heat arising in the process and prevents the adjacent battery cells also from overheating or starting to burn by the PU foam melting. This prevents a fire from arising or expanding rapidly. The PU foam also prevents the entire electric vehicle or the entire house from burning off as a result of a defective battery cell.

Two monomers (for example a polyol and a polyisocyanate) are used for the production (polymerization) of PU foam. The foaming can take place chemically and/or physically.

Conventional solutions for producing and applying foam, in particular PU foam, have the disadvantage that no interruption-free conveyance of the components or no interruption-free production of the foam is possible. To date, the components have in each case been preconditioned or prepared in a tank and, if appropriate, already mixed with air in the tank. The plurality of components were then fed to a mixer and/or applicator. The component tank has to be replaced regularly or loaded with new material. Furthermore, it is not possible to set precisely the mixing ratio of the components in the foam since the components are already fed to the mixer or applicator in an air-displaced state. Therefore, the metering of the components is inaccurate and the ratio between the components among one another, and in particular the ratio between air and the other components, cannot be set or can be set only with difficulty. Furthermore, the mixer or applicator drips after a stop of the foam production.

Unsolved is therefore the problem of how a material quality of the foam and a mixing quality can be increased. In particular, unsolved is how a foam can be produced and applied in a clean, precise, reproducible, homogeneous and efficient manner.

### SUMMARY OF THE INVENTION

It is an object of the invention to improve an application device and an application system for producing and introducing/applying a multicomponent mixture, in particular PU foam, into/onto an object, in particular a lithium-ion battery. It is also an object of the invention to improve a method for producing and introducing/applying a multicomponent mixture, in particular PU foam, into/onto an object, in particular a lithium-ion battery.

It is an object of the invention to increase the efficiency in the production and introduction/application of PU foam. In particular, it is an object of the invention to enable an interruption-free production and introduction/application of PU foam.

It is an object of the invention to improve a homogeneity, controllability and precision in the production and introduction/application of PU foam. In particular, it is an object of the invention to improve the precision of a mixing ratio of the components, including air, of the PU foam.

It is an object of the invention to improve the cleanliness in the introduction/application of PU foam. In addition, it is an object of the invention to increase the flexibility in the use of different components for producing the PU foam.

The objects are formulated by way of example for PU foam and the use thereof for batteries. However, the disclosure is not restricted thereto and can be used generally in the production and application of multicomponent mixtures and/or foams composed of one or more components which are mixed with air. The use in batteries is also mentioned here merely by way of example. Such multicomponent mixtures and foams can be used in different sectors, for example in the production of building materials.

At least one of the objects is achieved by the subject matter of the independent claims. Advantageous embodiments and developments emerge from the subject matter of the dependent claims.

In the context of the disclosure, “application to an object” is to be regarded as synonymous with “application to an object”. Embodiments of the disclosure are described with reference to the application of a multicomponent mixture to an object. This is also intended to cover the case in which the multicomponent mixture is introduced into the object. In the context of the disclosure, a “battery” is to be regarded as synonymous with an “accumulator”. An “application device” may also be referred to in short as an “applicator” and constitutes a device for applying or applying a mixture. In the context of this disclosure, a “mixture” is to be understood as synonymous with “mixture”. A multicomponent mixture refers to the mixture of a first component with at least one further component, in particular a gas or a gas mixture, for example air. A foam refers to a multicomponent mixture composed of a first component and, as a second component, composed of a gas or gas mixture, in particular air, and optionally composed of further components. Unless stated otherwise, a “component” refers to a material. The specification of different components serves to distinguish different materials. In the context of this disclosure, a polyurethane may also be referred to as a multicomponent mixture.

As a result of the stated invention, all the components, including, if appropriate, the gas or gas mixture, are mixed with a mixer only in the application device.

As a result of the stated invention, it is achieved that, by moving the mixer along the mixing tube, the second, open end of the mixing tube can be closed in a rapidly simple manner. As a result, the multicomponent mixture can be effectively prevented from emerging from the mixing tube. This is advantageous in particular when the application of the multicomponent mixture onto the object is intended to be ended. Furthermore, dripping of the multicomponent mixture from the application device can be prevented. As a result, clean application of the multicomponent mixture can be ensured.

By means of embodiments of the disclosure, a mixing section is furthermore defined along the mixing tube with a closed end and an open end. By means of the mixing section, a sequence is predefined on the basis of which the plurality of components for the production of the multicomponent mixture are injected into the mixing space and mixed with one another. In this case, on the one hand, it can be ensured that the sequence of mixing of the components is adhered to.

Furthermore, this sequence can be made flexible by varying one or more positions at which the one or more components are injected into the mixing space. Furthermore, the type of the injected components can be changed in a simple manner and the components injected at the corresponding positions can be replaced. As a result, different multicomponent mixtures can be produced in a simple manner. Furthermore, by setting the material flow of the injected components, a mass or volume ratio of the injected or mixed components can be set in a simple manner. In particular, a ratio between the first component/third component and gas or air can be set precisely, as a result of which the material quality of the multicomponent mixture and/or a mixing quality can be increased.

Furthermore, a prepared or stirred material of the first or third component can be provided by devices for material treatment which are correspondingly connected upstream of the mixer. As a result, the material always has the same material properties before it is injected into the mixing chamber. In particular, a homogeneity of the injected components can be increased. As a result, a material quality of the multicomponent mixture and a mixing quality can likewise be increased. Furthermore, effects such as so-called “sacking” are prevented.

By means of embodiments of the disclosure, it is furthermore achieved that the first component and the third component are mixed with gas only in the mixing chamber of the application device. As a result, these components can be metered in a gas-free or air-free state and injected into the mixing chamber. Therefore, metering is no longer dependent on an amount or a volume of gas which is contained in the components. In particular, the gas volume would be highly dependent on a pressure in the lines which conduct the components. As a result, the accuracy during metering is significantly increased. As a result, in turn, a ratio between the first component or third component and gas, in particular air, can be set and regulated precisely. As a result, a material quality of the multicomponent mixture and a mixing quality can be increased.

By way of embodiments of the disclosure, a mixing tube with different internal diameters is also specified. The different internal diameters result in different rotational speeds of the material of the components along the mixing tube during mixing of the components in the mixing space by means of the mixer. This enables a more flexible mixing of the components and an improved mixing, in particular an increased homogeneity of the mixing.

According to a first aspect of the disclosure, an application device for mixing a plurality of components for producing a multicomponent mixture and for introducing and/or applying the multicomponent mixture into and/or onto an object is specified.

The application device comprises a mixing tube with a first closed end and a second end for discharging the multicomponent mixture from the mixing tube. The mixing tube can comprise a mixing space between the first end and the second end.

The application device comprises a plurality of injection units, which are each configured to inject a corresponding one of the plurality of components into the mixing space. The plurality of injection units can be arranged on the mixing tube. The plurality of injection units can be arranged on a wall of the mixing tube, in particular on an outer side of the wall.

The application device comprises a mixer arranged at least partially in the mixing space. The mixer can be arranged completely in the mixing space. Preferably, a central piece and mixing elements of the mixer can be arranged in the mixing space. The mixer is configured to mix the injected components with one another. The mixer can be configured to mix the injected components with one another in the mixing space or in the mixing tube, preferably along the mixing tube proceeding from the first end towards the second end.

The application device further comprises a movement device which is configured to move the mixer along a central axis of the mixing tube and/or between the first end and the second end. The central axis may also be referred to as a longitudinal axis.

According to a second aspect of the disclosure, an application system for mixing a plurality of components for producing a multicomponent mixture and for introducing and/or applying the multicomponent mixture into and/or onto an object is provided.

The application system comprises an application device of aspects and embodiments of the disclosure.

Furthermore, the application system can comprise at least one first device for material treatment which is configured to provide a material flow of the first component and/or at least one second device for material treatment which is configured to provide a material flow of the third component.

Furthermore, the application system can comprise at least one first metering device which is configured to receive the material flow of the first component, to set a mass flow and/or volume flow of this component and to provide the material flow to the at least one first injection unit of the application device.

Furthermore, the application system can comprise a second metering device which is configured to receive a material flow of the second component, to set a mass flow and/or a volume flow of the second component and to provide the material flow to the at least one second injection unit of the application device. According to preferred embodiments, the second component is a gas or a gas mixture, preferably air, and the material flow of the second component is a flow of the gas or gas mixture, preferably an air flow.

Furthermore, the application system can comprise at least one third metering device which is configured to receive the material flow of the third component, to set a mass flow and/or volume flow of these components and to provide the material flow to the at least one third injection unit of the application device.

The application device or the application system of an aspect or an embodiment of the disclosure can be configured to carry out methods of an aspect or an embodiment of the disclosure. Methods of an aspect or an embodiment of the disclosure can be carried out by means of an application device or an application system of an aspect or an embodiment of the disclosure.

According to a further aspect of the disclosure, the use of an application device or an application system of embodiments of the disclosure in a method of embodiments of the disclosure is specified.

According to yet a further aspect of the disclosure, a method of embodiments of the disclosure using an application device or an application system of embodiments of the disclosure is specified. The aspects of the disclosure can have one or more of the following features.

The method can take place in such a way that the mixing tube is sealed with respect to a material flow of the plurality of components and/or of the multicomponent mixture from the second end of the mixing tube and/or towards the second end.

The mixer can be moved along the mixing tube between a first position and a second position. The second position can lie closer to the second end than the first position along the mixing tube, in particular along the central axis. On the other hand, the first position can lie closer to the first end than the second position along the mixing tube. The mixer can be moved from the first position in the direction of the second end into the second position.

Alternatively or additionally, the mixer can be moved from the second position in the direction of the first end into the first position. This method can likewise have the effect that the mixing tube is sealed with respect to a material flow of the plurality of components and/or of the multicomponent mixture from the second end and/or towards the second end.

The mixing tube can have at least one sealing element. The mixing tube can have a plurality of sealing elements. The sealing element can be arranged on or in the region of the second end of the mixing tube, or the sealing element can be formed by the second end of the mixing tube.

The sealing element can be configured as a ring or substantially annularly. A movement of the mixer towards the second end or a movement away from the second end can have the effect that the mixer, in particular a mixing element of the mixer, comes into contact with the sealing element and the mixing tube is thereby sealed.

The sealing element can also be configured as a cone or substantially conically. This can mean that a surface of the sealing element directed in the direction of the central axis of the mixing tube is conical. In particular, the sealing element can be configured as a conical seat for an end of the mixer.

The mixer can have a conical, frustoconical, conical, needle-shaped or pointed end which lies opposite the second end of the mixing tube. A movement of the mixer towards the second end can have the effect that the end of the mixer comes into contact with the sealing element and the mixing tube is thereby sealed.

The sealing element and the first end of the mixer can form a needle valve.

The mixer can be moved in such a way that the end of the mixer and the sealing element of the mixing tube overlap in a plane perpendicular to the central axis of the mixing tube and/or that the first end of the mixer and the sealing element of the mixing tube are in contact.

The application device can further comprise a rotation device, preferably an electric motor, particularly preferably a servo electric motor. The rotation device can be configured to rotate the mixer, preferably about an axis of rotation which is substantially parallel to the central axis of the mixing tube. The central axis of the mixing tube and the axis of rotation of the mixer can substantially coincide or overlap. The movement of the mixer can take place along the axis of rotation of the mixer.

The mixer can have a plurality of sections along the axis of rotation and/or along the central axis of the mixing tube, wherein at least two of the plurality of sections have mutually different outer diameters.

The mixer can have a first section and a second section. The first section can have a larger outer diameter than the second section or vice versa. The first section can be arranged closer to the first end than the second section with respect to the central axis of the mixing tube. The first section can be arranged above the second section in the vertical direction.

The mixer can have a third section which is arranged closer to the second end of the mixing tube than the first section and/or second section of the mixer with respect to the central axis of the mixing tube. The third section can have a different outer diameter than the first section and/or the second section. The third section can have a larger outer diameter than the first section and/or the second section. The third section can have a smaller outer diameter than the first section and/or the second section.

The mixing tube can have a plurality of sections along the central axis. The wall of the mixing tube can have a substantially constant inner diameter within each section. The wall of the mixing tube can have mutually different inner diameters in or between at least two of the plurality of sections. The wall in one of the sections can have a different inner diameter than an inner diameter of the wall in at least one other of the plurality of sections. An inner diameter of the mixing tube can be defined as an inner diameter of the tube wall, wherein any mixing elements of the mixing tube are not taken into account.

The plurality of sections can have a first section and a second section. The first section can be arranged at or adjacent to the first end. The second section can be arranged between the first section and the second end along the central axis. The wall in the first section can have a larger inner diameter than in the second section or vice versa. The first section can be arranged closer to the first end of the mixing tube than the second section. The first section can be arranged above the second section with respect to a vertical direction. The first section may also be referred to as an upper material chamber.

The plurality of sections can have a third section. The third section can be arranged between the second section and the second end along the central axis. The wall of the mixing tube in the third section can have a different inner diameter than in the second section and/or in the first section. The third section can be arranged closer to the second end of the mixing tube than the second section. The wall in the third section can have a smaller inner diameter than in the first section and/or in the second section. The wall in the third section can have a larger inner diameter than in the first section and/or in the second section.

The plurality of injection units of the application device can comprise at least one first injection unit and/or at least one second injection unit and/or at least one third injection unit.

The at least one first injection unit can be arranged on the wall of the mixing tube in the first section of the mixing tube. The at least one first injection unit can be configured to inject a first component into a region of the mixing space which adjoins the first section of the mixing tube.

The at least one second injection unit can be arranged on the wall of the mixing tube in the second section of the mixing tube. The at least one second injection unit can be configured to inject a second component into a region of the mixing space which adjoins the second section of the mixing tube.

The at least one third injection unit can be arranged on the wall of the mixing tube in the third section of the mixing tube. The at least one third injection unit can be configured to inject a third component into a region of the mixing space which adjoins the third section of the mixing tube.

The application device can have at least one pressure sensor. Preferably, at least one pressure sensor is provided for at least one of the plurality of sections of the mixing tube, which pressure sensor is configured to measure a pressure in the region of the mixing space adjoining the respective section.

The application device can comprise a first pressure sensor configured to measure a pressure in the region of the mixing space adjoining the first end of the mixing tube and/or adjoining the first section of the mixing tube. The application device can comprise a second pressure sensor configured to measure a pressure in the region of the mixing space adjoining the second section of the mixing tube. The application device can comprise a third pressure sensor configured to measure a pressure in the region of the mixing space adjoining the second end of the mixing tube and/or adjoining the third section.

A central axis of the mixer can extend substantially along the mixing tube, in particular along the central axis. The mixer can be substantially rod-shaped or have a rod. The mixer can have a central piece which is configured substantially rotationally symmetrically and/or is substantially rod-shaped or is a rod. The central piece can extend substantially along the central axis of the mixing tube. An axis of symmetry or central axis of the central piece can substantially coincide with the central axis of the mixing tube.

The mixer can have at least one mixing element. The mixing element serves for efficient mixing of the injected components by the mixer. The mixing element can extend in the radial direction of the mixer. The mixing element can be arranged on an outer side of the central piece and/or a lateral surface of the central piece, and/or extend in a radial direction of the central piece. According to preferred embodiments, the mixer has a plurality of mixing elements. The plurality of mixing elements can be arranged distributed along the central piece and/or with respect to the central axis. In addition, the plurality of mixing elements can be arranged distributed in the circumferential direction of the central piece. Particularly preferably, the mixing elements are configured and/or arranged in such a way that no imbalance forms when the mixer is rotated about the axis of rotation. The axis of rotation of the mixer can coincide with the axis of symmetry.

The at least one mixing element can be configured as a lamella, tine, hook or rod. The at least one mixing element can be configured as a ring surrounding the central piece. The at least one mixing element can be configured as a thread or as a helix or comprise the latter.

The application device can have at least one mixing element. The mixing element can be arranged on the wall, in particular on an inner side of the wall of the mixing tube, and extend into the mixing space. The mixing element can extend towards the central axis of the mixing tube. The mixing element can be configured as a ring. The mixing element can be configured as a lamella, tine, hook or rod, or wherein the at least one mixing element is configured as a regular or irregular structure.

The mixing tube can be configured substantially straight. This can mean that a center line of the mixing tube or of the mixing space is straight. The mixing tube can be oriented substantially vertically. The first end can be arranged above the second end. A length of the mixing tube can be greater than the inner diameter of the wall of the mixing tube. An inner side of the wall of the mixing tube can be rotationally symmetrical about the central axis.

The movement device can be configured as a lifting cylinder, in particular as an electric lifting cylinder or electric-hydraulic lifting cylinder, or comprise the latter.

According to embodiments, the application device comprises a plurality of first injection units, and/or a plurality of second injection units and/or a plurality of third injection units. Correspondingly, the application system can comprise a plurality of first metering devices, a plurality of first devices for material treatment, a plurality of second metering devices, a plurality of second devices for material treatment and a plurality of third metering devices.

The injection units can be configured to receive the material flow of the corresponding component from the corresponding metering devices.

By means of the mixing space, a mixing section can be defined starting from the first end towards the second end. The plurality of injection units can each be configured to inject the corresponding one of the plurality of components into the mixing space at a corresponding position along the mixing section.

The first injection unit can be configured to inject the first component at a first position along the mixing section. The second injection unit can be configured to inject the second component at a second position, which is arranged along the mixing section at or behind the first position. The second component can be or comprise a gas or a gas mixture, preferably air. The third injection unit can be configured to inject the third component at a third position. The third position can be arranged along the mixing section at or behind the second position.

The mixer can be configured to mix the injected components with one another on the basis of the sequence in which they have been or are injected at the corresponding positions along or with respect to the mixing section, or along the mixing space. The injected components can also be mixed with one another on the basis of this sequence. By mixing the injected components, the multicomponent mixture can be produced. Subsequently, the multicomponent mixture can be discharged from the mixing tube and the application device via the second end of the mixing tube, and the multicomponent mixture can be applied onto an object.

The closed first end can be sealed with respect to the components injected into the mixing space. The open second end serves to discharge the produced multicomponent mixture from the mixing tube. The mixing section can be defined as a course of the central axis of the mixing tube proceeding from the first end towards the second end. The respective position along the mixing section can be defined as a projection of the respective injection point onto the center line of the tube.

The injection units may also be referred to as injection units. The injection units can each have a nozzle which is configured to inject the corresponding component into the mixing space.

The mixer can be configured to mix the first component and the second component with one another first along the mixing section. The mixer can be configured to next mix the mixture of the first component and the second component with the third component with one another. Correspondingly, a method of embodiments and aspects of the disclosure can further comprise mixing, by means of the mixer, the mixture of the first component and the second component with the third component for producing the multicomponent mixture comprising the third component.

The mixing of the components can take place by rotating the mixer. The mixer can be rotated about an axis of rotation. The axis of rotation can be substantially parallel to the central axis or a center line of the mixing tube.

The injection units can comprise at least one fourth injection unit for injecting a fourth component at a fourth position, which is arranged along the mixing section in front of the third position, in particular between the second position and the third position.

The injection units can comprise at least one fifth injection unit for injecting a fifth component at a fifth position, which is arranged along the mixing section in front of the third position, in particular between the second position and the third position, in particular behind the fourth position.

The mixer can be configured to first mix the first component and the second component along the mixing section, next mix the mixture of the first component and the second component with the fourth component or with the fifth component, or next mix the mixture of the first component and the second component with the fourth component and then mix the mixture of the first component, the second component and the fourth component with the fifth component. The mixer can be configured to mix the mixture of the first component, the second component, the fourth component and/or the fifth component with the third component.

Each of the injection units can be arranged on the mixing tube, in particular on a wall of the mixing tube. For example, the injection units are arranged on an outer side of the wall of the mixing tube.

The mixing tube can have a plurality of injection points for injecting a corresponding one of the components. An injection point can be configured as a hole or bore through the wall of the mixing tube. Each of the injection units can be arranged on a corresponding one of the injection units. Each of the injection units can be configured to be attached to a corresponding one of the injection points. Each of the injection points can correspond to a specific position along the mixing section defined by the mixing space.

At least one of the plurality of injection units can be configured to be removable from the mixing tube, in particular from the wall of the mixing tube, and/or configured to be displaceable along the mixing tube. As a result, the injection unit can be arranged at different injection points on the mixing tube. The corresponding component can thus be injected into the mixing space at at least two different positions along the mixing section. As a result, the sequence of the injection and of the mixing of the components can be made even more flexible.

The plurality of injection units can comprise a plurality of first injection units, for example two or three. The plurality of first injection units can each be configured to inject a corresponding one of a plurality of first components at a corresponding one of a plurality of first positions along the mixing section. The plurality of injection units can comprise a plurality of second injection units, for example two or three. The plurality of second injection units can each be configured to inject a corresponding one of a plurality of second components at a corresponding one of a plurality of second positions along the mixing section. In particular, each of the second positions can be arranged along the mixing section behind each of the first positions. The plurality of injection units can comprise a plurality of third injection units, for example two or three. The plurality of third injection units can each be configured to inject a corresponding one of a plurality of third components at a corresponding one of a plurality of third positions along the mixing section. In particular, each of the third positions can be arranged along the mixing section behind each of the second positions. The same can apply to the fourth and fifth injection units for injection. Each of the at least one first to fifth components can also be injected multiple times.

Alternatively or additionally, the plurality of injection units can have a plurality of first injection units, wherein each of the plurality of first injection units is configured to inject the first component at a corresponding one of a plurality of first positions. The plurality of injection units can have a plurality of third injection units, wherein each of the plurality of third injection units is configured to inject the third component at a corresponding one of a plurality of third positions. As a result, it is possible to vary at which position or with which injection unit the first, third, fourth or fifth component is injected into the mixing space. This is advantageous when one injection unit has to be serviced. It is then possible to deviate to another injection unit for the same component.

At least one of the first, third, fourth and fifth components can be or comprise a fluid, and/or can be liquid (at 20° C. and 1 bar). In particular, the first component and/or the third component can be liquid. The components can have a dynamic viscosity, in particular determined in accordance with DIN EN ISO 2884 at 20° C., of between 0.5 mPa s and 100.000 mPa s.

Each of the at least first, third, fourth and fifth components can be one of the following or comprise at least one of the following: water, a starter, an inhibitor, an accelerator, a booster, a monomer, a monomer for the polymerization of polyurethane, a polyol, a diol, polyisocyanate, isocyanate, diisocyanate, moist air. Preferably, each of the components comprises at most one monomer for the polymerization of polyurethane. The at least second component can be one of the following or comprise at least one of the following: a technical gas, N2, CO2, NO, a mixture of at least two of the gases mentioned.

By mixing the plurality of components, the multicomponent mixture can be produced. In particular, by mixing the gas or the gas mixture with at least one other component, a foam can be produced. This may also be referred to as foaming, in particular as physical foaming. In particular, by mixing the first component and/or the third component with the gas or the gas mixture, a foam can be produced.

The first component can comprise a first monomer for the polymerization of polyurethane. The third component can comprise a second monomer for the polymerization of polyurethane. Polyurethane can be polymerized by a chemical reaction of the first monomer with the second monomer. The polymerization can take place in the mixing space and/or outside the mixing space, after discharging the polyurethane from the mixing space. The polyurethane can be foamed, in particular physically foamed, by the gas or the gas mixture.

The first component can be or comprise a polyol, in particular diol, and/or the third component can be or comprise a polyisocyanate, in particular diisocyanate. Alternatively, the first component can be or comprise a polyisocyanate, and/or the third component can be or comprise a polyol. The fourth component can in particular be or comprise an accelerator or booster for the third component and/or the first component. The fifth component can in particular be or comprise water. The injection of water can be used for rinsing the mixer and/or the mixing tube.

The application device can comprise a rinse injection unit. The rinse injection unit can be configured to inject a rinse medium into the mixing space for rinsing the mixing space. The rinse medium can be or comprise a fluid, in particular water. The rinse injection unit can, with respect to the first to fifth injection units, inject the rinse medium into the mixing space at an arbitrary position along the mixing section. Additionally or alternatively, one of the first to fifth injection units can be used for injecting a rinse medium.

The produced multicomponent mixture can emerge independently from the mixing tube and the application device at the second end. This can take place in particular in that the mixing tube is arranged vertically. The material of the multicomponent mixture then already emerges as a result of gravity. Because the first end of the mixing tube is closed and the components are injected into the mixing space, the material of the multicomponent mixture is also forced out of the mixing tube by the material of the injected components flowing in. Alternatively or additionally, the mixer can be configured in such a way that rotation of the mixer forces the material of the multicomponent mixture out of the mixing tube.

The produced multicomponent mixture can be a foam, in particular a PU foam. The produced multicomponent mixture can be applied onto an object or introduced into the object. In particular, a PU foam can be applied onto or introduced into a lithium-ion battery.

The object can be a lithium-based battery or battery cell, or a lithium-ion battery or battery cell. The multicomponent mixture can be or comprise a polyurethane foam.

Each of the metering devices can also be configured to set a volume flow of the corresponding components. The first metering device can be configured to measure a mass flow and/or a volume flow of the first component. The third metering device can be configured to measure a mass flow and/or a volume flow of the third component. Between a volume or a volume flow and a mass or a mass flow of the respective component, it is possible to convert in a simple manner on the basis of pressure, temperature and/or molar volume.

According to preferred embodiments, the application system comprises at least two first devices for material treatment for the first component and/or at least two second devices for material treatment for the third component. Here, each of the first devices can provide a material flow to the first metering device. The first metering device can be configured to receive a material flow from one of the two first metering devices, or to receive a material flow from the two first devices for material treatment at the same time. The same applies correspondingly to the second devices for material treatment and the third metering device for the third component. By providing two devices for material treatment per component, it can be ensured that the respective metering device continuously receives a material flow. As a result, continuous operation of the application system can be ensured.

The first component and/or the third component can be injected into the mixing space in an air-free state and/or in a gas-free state.

The mixer can be configured to mix the injected components with one another on the basis of the sequence in which they are injected at the corresponding positions along the mixing section.

The first pressure sensor can be configured to measure a pressure in the mixing space at a position along the mixing section in the region of the first position or between the first position and the second position. The second pressure sensor can be configured to measure a pressure in the mixing space at a position along the mixing section in the region of the second position or between the second position and the third position. The third pressure sensor can be configured to measure a pressure in the mixing space in the region of the third position or at a position along the mixing section after the third position and/or between the third position and the second end.

The application system can be configured to mix the first component and/or the third component with the gas or the gas mixture in the mixing chamber of the application device, in particular exclusively in the mixing chamber.

The application system can be configured to mix the first component with the gas or gas mixture in a or with respect to a material flow direction of the first component not upstream of the first metering device or upstream of the application device. The application system can be configured to mix the third component with the gas or gas mixture in a or with respect to a material flow direction of the third component not upstream of the third metering device or upstream of the application device.

The second metering device can comprise a measuring unit and an actuator. The measuring unit can be a gas mass sensor or gas quantity sensor. The actuator can be a controlled or regulated gas valve, in particular a proportional gas valve. The measuring unit can be configured to receive a flow of the gas or gas mixture from a gas supply device of the application system, to measure a mass flow and/or a volume flow and to provide the flow to the actuator. The actuator can be configured to receive the flow, to set the mass flow and/or the volume flow of the flow of the gas or gas mixture and to provide the flow to the second injection unit. Alternatively or additionally, the actuator can be configured to set a pressure in a line which conducts the flow of the gas or gas mixture, preferably the second line. Alternatively or additionally, the measuring unit can be configured to set an amount and/or a volume flow and/or a mass flow of the flow of the gas or gas mixture. For air, the measuring unit can be an air mass sensor or an air quantity sensor, the gas valve can be an air valve and the gas supply device can be an air supply device, be configured as an air pump or comprise an air pump. A quantity sensor can also be referred to as a flow meter.

The application system can furthermore comprise a first line, preferably a channel, a hose or a tube, between the gas supply device and the second metering device. The application system can comprise a second line, preferably a channel, a hose or a tube, between the second metering device and the application device, for conducting the flow of the gas or gas mixture. A line can also be referred to as a fluid conducting element.

The application system can furthermore comprise a first line pressure sensor which is configured to measure a pressure, in particular a gas pressure or an air pressure, in the first line. The application system can comprise a second line pressure sensor configured to measure a pressure, in particular a gas pressure or an air pressure, in the second line.

The application system can furthermore comprise a control unit. The control unit can comprise a computing unit, for example a microprocessor. A method of embodiments and aspects of the disclosure can comprise a control step. The control unit can be configured to carry out the control step. The control can be carried out using the control unit.

The control can comprise an actuation of the rotation device for the mixer and/or the first metering device and/or the second metering device and/or the third metering device and/or the gas supply device. The control unit can be configured to correspondingly actuate the rotation device, the first metering device, the second metering device, the third metering device and/or the gas supply device.

The actuation of the rotation device can serve to set the rotational speed of the mixer. The actuation of the first metering device can serve to set the mass flow and/or the volume flow of the first component. The actuation of the second metering device can serve to set the mass flow and/or the volume flow of the second component. The actuation of the second metering device can comprise the actuation of the actuator and/or of the measuring unit, which can serve to set the mass flow and/or the volume flow of the second component and/or a pressure in a line which conducts the gas or gas mixture. The actuation of the third metering device serves to set the mass flow and/or volume flow of the third component. The actuation of the gas supply device can serve to set a pressure of the flow of the gas or gas mixture and/or a pressure in a line which conducts the gas or gas mixture, for example the first or second line.

The control can be carried out on the basis of a setpoint value for a ratio between a mass flow of the second component and the mass flow of the first component, and/or a setpoint value for a ratio between the mass flow of the second component and the mass flow of the third component, and/or a ratio between a mass flow of the first component and the mass flow of the third component, in particular a ratio of the respective mass flows which are injected into the mixing chamber. Alternatively or additionally, the control can also be carried out on the basis of a ratio between the corresponding volume flows.

Alternatively or additionally, the control can be carried out on the basis of a value for the mass flow of the second component and/or a value for the mass flow of the first component and/or a value for the mass flow of the third component and/or a value for the rotational speed of the mixer and/or a value for a pressure in the mixing chamber and/or a value for the pressure in the first line and/or a value for the pressure in the first or second line. The specified values can be set values or measured values of the corresponding specified variables. Alternatively or additionally, the control can also be carried out on the basis of the values for the corresponding volume flows.

The control can comprise a control of a mixing ratio of the plurality of components in the multicomponent mixture. The control can comprise a control of a ratio between the mass and/or the volume of the second component and a mass and/or the volume of at least one of the other components in the multicomponent mixture. The control can comprise a control of a ratio between the mass flow and/or volume flow of the second component and a mass flow and/or volume flow of at least one of the other components. The control can comprise a control of a ratio between the mass and/or the volume of the second component and a mass and/or the volume of at least one of the other components in the multicomponent mixture. This can also apply correspondingly to each of the other components. The mass flows or volume flows can be the flows of the material flows of the components which are injected into the mixing chamber.

The control can comprise the control of the ratio between the mass flow of the second component and the mass flow of the first component and/or a control of the ratio between a mass flow of the second component and the mass flow of the third component, and/or of the ratio between a mass flow of the first component and the mass flow of the third component. Alternatively or additionally, the control can also be carried out by a control of the ratio between the corresponding volume flows of the components. The control can be carried out in particular by actuation of the second metering device and/or by actuation of the first metering device and/or by actuation of the third metering device and/or by actuation of the gas supply device and/or by actuation of the rotation device. A setpoint value for the ratio can be predefined by the control unit or by an external system or a user of the application device. The setpoint value can be predefined by a mathematical function.

The control can comprise a control of a mass flow and/or volume flow of the second component, in particular in such a way that it is proportional to the mass flow and/or volume flow of the first component and/or to the mass flow and/or volume flow of the third component and/or proportional to the rotational speed of the mixer. The control can be carried out in particular by actuation of the second metering device and/or by actuation of the first metering device and/or by actuation of the third metering device and/or by actuation of the gas supply device and/or by actuation of the rotation device.

The control can comprise a control of a pressure of the second component, in particular in a line for conducting the material flow of the second component, for example the first line or the second line, and/or at the second injection point for the second component, in such a way that this pressure is greater, preferably by 1 bar greater, than a pressure in the mixing space, preferably at a position in the region of the first position along the mixing section. The control can be carried out in particular by actuation of the gas supply device and/or the second metering device.

The control can comprise a control of a pressure of the second component, in particular in a line for conducting the material flow of the second component and/or at the second injection point for the second component, in such a way that the second component is injected into the mixing space at a greater pressure than the first component and/or than the third component. Preferably, the difference can be 1 bar or more.

The control can comprise the control of a rotational speed of the mixer, in particular in such a way that the rotational speed is proportional to the mass flow and/or volume of the first component and/or proportional to the mass flow and/or volume flow of the third component. The control can be carried out in particular by actuation of the rotation device.

The first component and/or the third component can be injected into the mixing space in an air-free and/or gas-free state. The first component can pass the first metering device in an air-free or gas-free state. The third component can pass the third metering device in an air-free or gas-free state. The application system can be configured in such a way that the first component and/or the third component are injected in an air-free or gas-free state and/or pass the corresponding metering device.

The first metering device can be configured to receive the material flow of the first component from the first device for material treatment. The third metering device can be configured to receive the material flow of the third component from the second device for material treatment.

The mixing tube can furthermore have a further transition section in each case between two of the plurality of sections. The wall in each of the transition sections can have a variable, preferably a linearly variable, inner diameter along the central axis.

The mixer can have a respective section for each of the sections of the mixing tube, wherein each section of the mixing tube overlaps with the respective section of the mixer in a plane perpendicular to the central axis of the mixing tube. The plane can comprise a radial direction of the mixing tube.

The inner diameter of the mixing tube can be greater along the central axis of the mixing tube between the first end and the second end than the outer diameter of the mixer. The inner diameter of the mixing tube can be defined as an inner diameter of the wall of the mixing tube, wherein any mixing elements of the mixing tube are not taken into account. The extent of the mixer in a plane which comprises the radial direction of the mixing tube can be defined as an outer diameter of the mixer, wherein any mixing elements of the mixer are taken into account for the extent of the mixer.

The devices for material treatment (also referred to as material treatment device for short below), in particular the first device for material treatment and/or the third device for material treatment, can comprise a material container and a pump device. The material container can be configured to treat the corresponding component. The pump device can have an inlet and an outlet. The inlet of the pump device can be connected in a fluid-communicating manner to the material container, such that the component can be introduced from the material container into the pump device. The pump device can be configured to provide the component at the outlet of the pump device at a pressure of at least 15 bar.

According to a further aspect of the disclosure, a method for material treatment is specified. The method can comprise the steps of: treating a component, in particular a first component or a third component, in a material container; introducing the component from the material container into an inlet of a pump device; increasing the pressure of the component by means of the pump device; and discharging the component from an outlet of the pump device. The component can have a pressure of at least 15 bar at the outlet of the pump device.

Any material treatment device disclosed herein can be used in the method for material treatment.

Furthermore disclosed is a use of a material treatment device disclosed herein for the treatment of a component for the polymerization of polyurethane. The component can be a monomer for the polymerization of polyurethane.

The application device, in particular the first injection unit, can be connected in a fluid-communicating manner to the outlet of the first device for material treatment. The application device, in particular the third injection unit, can be connected in a fluid-communicating manner to the outlet of the second device for material treatment. As a result, the first component and the third component can be introduced into the application device, in particular the mixing space. The application device can be configured to mix the first component and the third component to form a mixture or a multicomponent mixture and to apply said mixture to an object, in particular to a battery or an accumulator.

Pressure values disclosed herein are absolute pressure values. The pressure values are also related to an absolute vacuum. The ambient pressure is approximately 1 bar.

By means of the treatment of the respective component, it is possible to achieve a constant state of the component before said component is provided with a relatively high pressure for further processing, as a result of which a high metering accuracy at a high volume flow is achieved. For example, components, such as components comprising monomers for the polyurethane polymerization, are often provided in barrels. If the components are stirred in order to ensure a homogeneous distribution of substances in the component, air is introduced into the component. The introduced amount of air can vary, such that an accurate metering of the component is made more difficult.

At the inlet of the pump device, the component can have a pressure of less than 1.0 bar. Preferably, the component has a pressure of less than 0.9 bar, more preferably less than 0.8 bar, more preferably less than 0.7 bar, more preferably less than 0.6 bar, at the inlet of the pump device. The component can have a pressure at the inlet of the pump device which is lower than the ambient air pressure. A vacuum can prevail at the inlet of the pump device.

The pump device can comprise or be a high-pressure pump. The pump device can comprise or be a piston pump. Preferably, the pump device comprises a high-pressure piston pump or is a high-pressure piston pump.

The pump device can comprise no diaphragm pump. In other words, a diaphragm pump cannot be contained in the pump device.

The pump device can be configured to provide the component at the outlet of the pump device at a pressure of at least 60 bar. Preferably, the pump device is configured to provide the component at the outlet of the pump device at a pressure of at least 60 bar, more preferably of at least 100 bar, more preferably of at least 200 bar, more preferably of at least 300 bar.

The pump device can be configured to provide the component at the outlet of the pump device at a pressure between 15 bar and 350 bar, in particular between 20 bar and 350 bar.

The pump device can be configured to increase the pressure of the material from the inlet to the outlet by at least 15 bar, preferably by at least 60 bar, more preferably by at least 100 bar, more preferably by at least 200 bar, more preferably by at least 300 bar.

The pump device can be configured to control or regulate or set a volume flow or mass flow of the component at the outlet of the pump device.

The pump device can comprise a drive. The drive can be a hydraulic drive, in particular a servo-hydraulic drive.

The material container can comprise at least one treatment unit. The treatment unit can be configured to treat a corresponding component in the material container. In particular, the treatment unit is configured to heat, degas, place under vacuum, stir and/or mix the component in the material container.

The material container can be heatable. Preferably, the material container comprises at least one heating element. The heating element can be an electric heating element. The heating element can be configured to heat the temperature of the corresponding component in the material container to a temperature of at least 30° C., preferably of at least 40° C., more preferably of at least 50° C., more preferably of at least 60° C., more preferably of at least 70° C., more preferably of at least 80° C., more preferably of at least 100° C.

A vacuum can be present in the material container. The pressure in the material container can be lower than the ambient air pressure. The pressure in the material container can be less than 1.0 bar, preferably less than 0.8 bar, more preferably less than 0.6 bar, more preferably less than 0.5 bar, more preferably less than 0.4 bar.

The material container can comprise a vacuum unit. The vacuum unit can be configured to provide a vacuum in the material container. The vacuum unit cannot be part of the material container and in particular be connected to the material container.

The material container can be configured to stir the component in the material container. Preferably, the material container comprises an agitator, more preferably a movable agitator. The agitator can be drivable by a drive.

The component can comprise a monomer for the polymerization of polyurethane. The component can be mixed downstream of the pump device with a further monomer for the polymerization of polyurethane. Polyurethane can be polymerized by a chemical reaction of the monomers.

Preferably, the component comprises at most one monomer for the polymerization of polyurethane. The component can comprise a polyol. In particular, the component comprises a diol. The component can comprise a polyisocyanate. In particular, the component comprises a diisocyanate. The component can be liquid (at 20° C. and 1 bar).

The component can have a dynamic viscosity, in particular determined in accordance with DIN EN ISO 2884 at 20° C., of between 0.5 mPa s and 100.000 mPa s.

In general, the first component can comprise a first monomer for the polymerization of polyurethane. The third component can comprise a second monomer for the polymerization of polyurethane. Polyurethane can be polymerized by a chemical reaction of the first monomer with the second monomer. The polyurethane can be foamed, in particular physically foamed, by gas.

According to a further aspect of the disclosure, an application device for mixing a plurality of components for producing a multicomponent mixture and for introducing and/or applying the multicomponent mixture into and/or onto an object is specified.

The application device comprises a mixing tube with a first closed end and a second end for discharging the multicomponent mixture from the mixing tube, wherein the mixing tube comprises a mixing space. The mixing space can be arranged between the first end and the second end.

The application device comprises a plurality of injection units, which are each configured to inject a corresponding one of the plurality of components into the mixing space. The injection units can comprise at least one first injection unit for injecting a first component, at least one second injection unit for injecting a second component, in particular a gas or gas mixture, preferably air, and at least one third injection unit for injecting a third component. The plurality of injection units can be arranged on the mixer.

The application device further comprises a mixer arranged at least partially in the mixing space, which mixer is configured to mix the injected components with one another. The mixer can be configured in particular to mix the injected components with one another in the mixing space, preferably along the mixing space and/or along the mixing tube. The mixer can be arranged completely in the mixing space.

According to a further aspect of the disclosure, a method for mixing a plurality of components for producing a multicomponent mixture is specified. The method comprises the steps of: injecting a first component by means of a first injection unit of an application device into a mixing space in a mixing tube of the application device, injecting a second component, in particular a gas or gas mixture, preferably air, by means of a second injection unit of the application device into the mixing space, mixing the first component with the second component by means of a mixer arranged in the mixing space for producing the multicomponent mixture.

The method can further comprise injecting a third component by means of a third injection unit of the application device into the mixing space and mixing the mixture of the first component with the second component with the third component for producing the multicomponent mixture comprising the third component. The method can further comprise discharging the multicomponent mixture from the mixing tube, in particular a second open end of the mixer. The method can further comprise applying the multicomponent mixture onto the object or introducing the multicomponent mixture into the object. The mixing can comprise rotating the mixer.

The injection of the first component can take place at a first position along a mixing section defined by the mixing space, the injection of the second component can take place at a second position, which lies along the mixing section at or behind the first position, and the injection of the third component can take place at a third position, which lies along the mixing section at or behind the second position.

The method can further comprise at least one of the following steps of: setting a mass flow and/or volume flow of a material flow of the first component and providing the material flow to the at least one first injection unit of an application device, setting a mass flow and/or volume flow of a material flow of the second component and providing the material flow of the second component to the at least one second injection unit of the application device, setting a mass flow and/or volume flow of a material flow of the third component and providing the material flow to the at least one third injection unit of the application device.

According to a further aspect, an application system comprising an application device of aspects and embodiments of the disclosure is specified. The application system can comprise at least one device for material treatment of aspects and embodiments of the disclosure.

### BRIEF DESCRIPTION OF THE DRAWINGS

The aspects of the disclosure are explained below on the basis of drawings. In the drawings:

FIG. 1A shows a schematic cross-sectional view of an application device of embodiments of the disclosure;

FIG. 1B shows a schematic cross-sectional view of an application device of further embodiments of the disclosure;

FIG. 2 shows a schematic cross-sectional view of a part of an application device of still further embodiments of the disclosure;

FIGS. 3A, 3B show schematic cross-sectional views of the second end of a mixing tube and a mixer in different positions of an application device of embodiments of the disclosure;

FIGS. 4A, 4B show schematic cross-sectional views of the second end of a mixing tube and a mixer in different positions of an application device of further embodiments of the disclosure;

FIGS. 5A, 5B show schematic cross-sectional views of the second end of a mixing tube and a mixer in different positions of an application device of still further embodiments of the disclosure;

FIG. 6 shows a schematic view of a mixing section of embodiments of the disclosure;

FIG. 7 shows a device for material treatment of embodiments of the disclosure;

FIG. 8 shows an enlarged illustration of a material container of a device for material treatment of embodiments of the disclosure;

FIG. 9 shows a schematic view of an application system of embodiments of the disclosure;

FIG. 10 shows a flow diagram of a method of embodiments of the disclosure;

FIG. 11 shows a flow diagram of a method of further embodiments of the disclosure; and

FIG. 12 shows a diagram for illustrating a control step of a method for mixing a plurality of components for producing a multicomponent mixture and for introducing/applying the multicomponent mixture into/onto an object of embodiments of the disclosure.

### DETAILED DESCRIPTION OF THE EMBODIMENTS

In the following, the same reference signs refer to the same or corresponding elements.

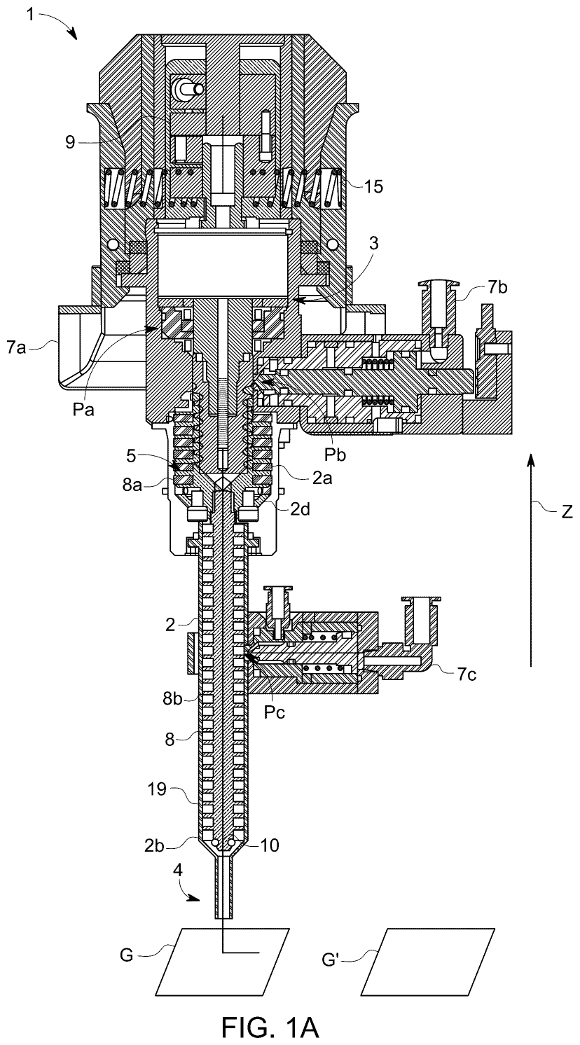

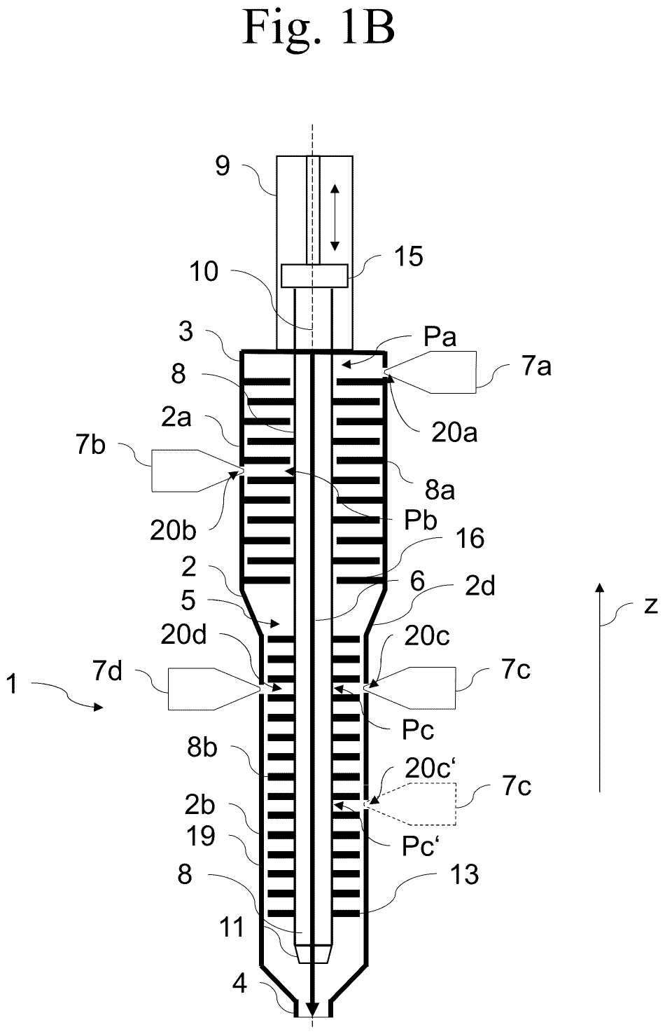

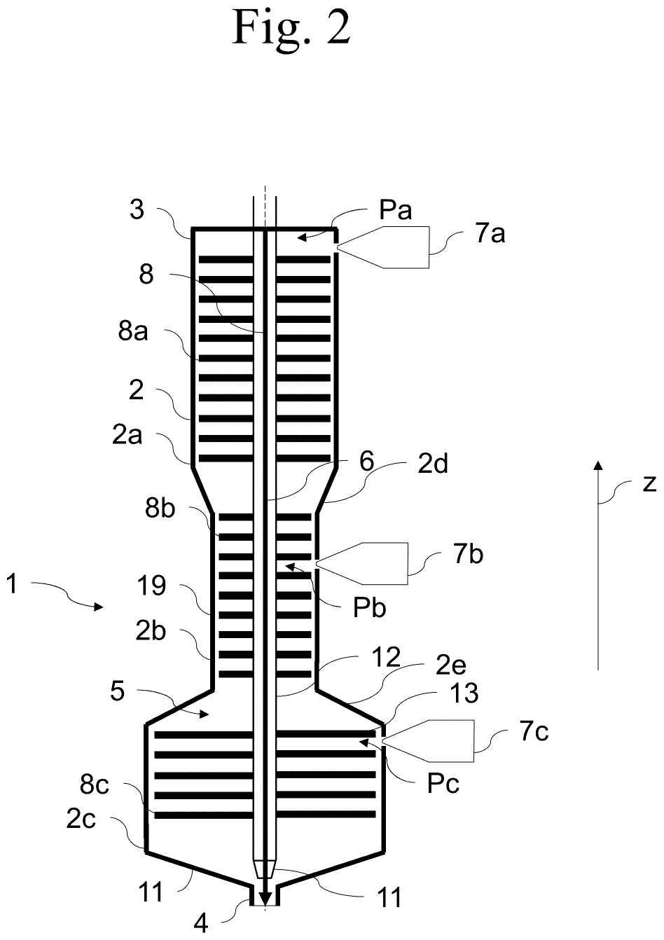

FIG. 1A shows a schematic cross-sectional view of an application device of embodiments of the disclosure. FIG. 1B shows a schematic cross-sectional view of an application device of further embodiments of the disclosure. FIG. 2 shows a schematic cross-sectional view of a part of an application device of still further embodiments of the disclosure.

The application device 1 is configured for mixing a plurality of components for producing a multicomponent mixture and for introducing and/or applying the multicomponent mixture into or onto an object G. The multicomponent mixture is, for example, polyurethane foam.

The PU foam can be applied into or onto the object by means of the application device 1. The object G is, for example, a lithium-ion battery or battery cell. For example, the PU foam can be introduced into an interior space of the battery and/or into an intermediate space between the battery cells of the battery. The PU foam serves, for example, for fire protection.

The application device 1 comprises a mixing tube 2 with a first end 3 and a second end 4. The first end 3 is closed. This means that the end is sealed with respect to components of the multicomponent mixture injected into the mixing tube 2. The second end 4 is open and serves to discharge the multicomponent mixture from the mixing tube 2. Between the first end 3 and the second end 4, the mixing tube 2 comprises a mixing space 5. The mixing space 5 defines a mixing section 6 proceeding from the first end 3 towards the second end 4. The mixing space 5 is arranged in the mixing tube 2. The mixing space 5 can also be referred to as a mixing chamber.

The mixing tube 2 is configured substantially straight. This means that a center line 10 of the mixing tube 2 is straight. The center line 10 can also be referred to as a central axis. The mixing tube 2 has a wall 19. An inner side of the wall 19 can be substantially rotationally symmetrical about the central axis 10, as shown. The inner side of the wall 19 adjoins the mixing space 5. The mixing tube 2 is oriented substantially vertically. This means that the central axis 10 runs substantially along a vertical spatial direction z.

As shown, the mixing tube 2 has a plurality of sections 2a, 2b, 2c along the central axis 10. In the embodiments of FIGS. 1A and 1B, the mixing tube has two sections 2a, 2b. In the embodiment of FIG. 2, the mixing tube has three sections 2a, 2b, 2c. However, the disclosure is not restricted thereto. For example, a first section 2a is arranged at or adjacent to the first end 3 and a second section 2b is arranged between the first section 2a and the second end 4 along the central axis 10. A third section 2c can be arranged at or adjacent to the second end 4. The third section 2c is arranged between the second section 2c and the second end 4 along the central axis 10, for example.

The wall 19 of the mixing tube 2 has a substantially constant inner diameter within each section 2a, 2b, 2c. However, the wall 19 of the mixing tube 2 has mutually different inner diameters between the sections 2a, 2b, 2c. Thus, the wall 19 has a different inner diameter in the section 2a than in the section 2b. Moreover, the wall 19 has a different inner diameter in the section 2b than in the section 2c. Furthermore, the wall 19 has a different inner diameter in the section 2a than in the section 2c. When considering the inner diameter, any mixing elements 16, as will be described in detail later, cannot be taken into account.

As shown in FIGS. 1A and 1B, the wall 19 has a larger inner diameter in the first section 2a than in the second section 2b. The first section 2a may also be referred to as an upper material chamber of the mixing tube 2 and the second section 2b may also be referred to as a lower material chamber.

As shown in FIG. 2, the wall 19 has a larger inner diameter in the third section 2a than in the sections 2a, 2b. According to further embodiments, the inner diameter in the third section 2c may also be smaller than in the sections 2a, 2b.

As shown, further transition sections 2d, 2e of the mixing tube 2, in which the wall 19 of the mixing tube 2 has a variable inner diameter, can be arranged between the sections 2a, 2b, 2c. The inner diameter can vary linearly along the central axis 10, for example. A transition can thus be created between the different inner diameters of the respective sections 2a, 2b, 2c.

The wall 19 of the mixing tube 2 has injection points 20a, 20b, 20c for corresponding injection units 7a, 7b, 7c, which are described in detail below. As shown, the injection points are arranged on the wall 19 of the mixing tube 2. However, the disclosure is not restricted thereto. The injection points serve merely to provide access for the injection units to the mixing chamber 5 for injecting the components. The injection points can be configured as holes or bores through the wall 19.

The application device 1 further comprises a plurality of injection units 7a, 7b, 7c. These are each configured to inject a corresponding component into the mixing space 5. As shown, the injection units 7a, 7b, 7c are arranged on the wall 19 of the mixing tube 2, more precisely on an outer side of the wall 19, but the disclosure is not restricted thereto. Each of the injection units 7a, 7b, 7c is arranged at a corresponding injection point 20, 20b, 20c and is configured to inject the corresponding component into the mixing space 5 via the injection point. The injection units 7a, 7b, 7c thus inject the corresponding component at a predetermined position Pa, Pb, Pc for this component along the mixing section 6.

As shown by way of example in FIG. 1A for the injection units 7b and 7c, each of the injection units 7a, 7b, 7c can have a nozzle. Each of the injection units is further configured to stop the injection of the component. For this purpose, each of the injection units 7a, 7b, 7c can have a corresponding inlet valve which is configured, for example, as a needle valve. The inlet valve 7a, 7b, 7c can be configured as a PWM valve. An injection of the respective component into the mixing space 5 can thus be stopped completely. This is necessary, for example, when sufficient PU foam has been applied onto the object G and a change is made to the next object G′. A material flow of the respective component can then be briefly interrupted by means of the inlet valves.

A first injection unit 7a is provided for injecting a first component via a first injection point 20a at a first position Pa along the mixing section 6. A second injection unit 7b is provided for injecting a second component via a second injection point 20b at a second position Pb along the mixing section 6. A third injection unit 7c is provided for injecting a third component via a third injection point 20c at a third position Pc along the mixing section 6. The second position Pb is arranged along the mixing section 6 behind the first position Pa, and the third position Pc is arranged along the mixing section 6 behind the second position Pb.

For cleaning and rinsing the application device 1, in particular the mixing tube 2, the mixer 8 and the mixing space 5, only air or the first component is injected into the mixing space 5. According to embodiments not shown, the application device 1 can furthermore comprise a rinse injection unit. The rinse injection unit can be configured to inject a rinse medium into the mixing space 5 for rinsing the mixing space 5 from the first to third components. The rinse medium can be water. The rinse injection unit can inject the rinse medium into the mixing space 5 at an arbitrary position along the mixing section 6. Additionally or alternatively, an injection unit can be used for injecting a rinse medium.

In the embodiment of FIG. 1B, a fourth injection unit 7d for injecting a fourth component is present. This is arranged at an injection point 20d which is at the same height as the injection point 20c of the third injection unit 7c. The injection point 20d can lie opposite the injection point 20c on the wall 19 with respect to the central axis 10. Consequently, the fourth component is injected at the same position 20c as the third component along the mixing section 6. According to embodiments not shown, the fourth injection unit 7d can be arranged along the mixing section 6 in front of the third position, in particular between the second position and the third position.

The injection units can comprise a fifth injection unit (not shown) for injecting a fifth component at a fifth position, which is arranged along the mixing section in front of the third position, in particular between the second position and the third position, for example behind the fourth position. The fourth component can in particular be a booster for the third component. The fifth component can in particular be water. According to embodiments, a plurality of first, second, third, fourth and/or fifth injection units can also be present.

The first to third injection units 7a, 7b, 7c are each configured to inject a fluid. According to embodiments, the second injection unit 7b injects, as a component, a gas or a gas mixture, for example air, into the mixing space 5. The first component 7a injects, as a second component, a polyol and the third injection unit 7b injects, as a component, a polyisocyanate or vice versa.

At least one of the injection units 7a, 7b, 7c can be configured to be removable from the wall 19. This is illustrated in FIG. 1A for the injection unit 7c. As a result, it is possible to offset and attach to another injection point, for example the injection point 20c′. As a result, it is possible to inject the third component flexibly at a plurality of positions Pc, Pc′ along the mixing section 6.

The application device 1 furthermore has a first pressure sensor (not shown) for measuring a pressure in the region of the mixing space 5 which adjoins the first section 2a of the mixing tube 2. Alternatively or additionally, the first pressure sensor can be configured to measure a pressure at a position along the mixing section 6 in the region of the first position Pa or at a position between the first position Pa and the second position Pb.

In addition, the application device 1 can have a second pressure sensor (not shown) for measuring a pressure in the region of the mixing space 5 which adjoins the second section 2b of the mixing tube 2. Alternatively or additionally, the second pressure sensor can be configured to measure a pressure at a position along the mixing section 6 in the region of the second position Pb or at a position between the second position Pb and the third position Pc. The application device 1 can furthermore comprise a third pressure sensor (not shown) for measuring a pressure in the region of the mixing space 5 adjoining the second end of the mixing tube 4 and/or adjoining the third section 2c. Alternatively or additionally, the third pressure sensor can be configured to measure a pressure at a position along the mixing section 6 in the region of the third position Pc or at a position after the third position Pc and/or between the third position Pc and the second end 4.

The application device 1 furthermore has a mixer 8 arranged at least partially in the mixing space 5. The mixer 8 can be arranged completely in the mixing space 5. Preferably, a central piece 12 and mixing elements 13 of the mixer 8 can be arranged in the mixing space 5. The mixer 8 can be configured as a rotor. The mixer 8 is configured to mix the injected components. For this purpose, the mixer 8 rotates in the mixing space 5. The axis of rotation of the mixer 8 is preferably parallel to the central axis of the mixing tube 2 or coincides therewith. To rotate the mixer, the application device 1 can have a rotation device 15, for example an electric motor. The mixer 8 and the mixing tube 2 can have been produced by means of 3D printing.

The mixer 8 mixes the injected components along the mixing space 5 or along the mixing section 6. The mixer 8 mixes the injected components on the basis of the sequence in which they are injected at the corresponding positions along the mixing section 6. By mixing the injected components, the multicomponent mixture is produced. For example, the PU foam is produced by mixing polyisocyanate with polyol and air.

The produced multicomponent mixture subsequently emerges independently from the mixing tube 2 and the mixer at the second end 4. This takes place in that the mixing tube 2 is arranged vertically and the material of the multicomponent mixture emerges as a result of gravity. Because the upper first end 3 of the mixing tube 4 is closed and when the components are continuously injected into the mixing space 5, the material of the multicomponent mixture is also forced out of the mixing tube 5 by the material of the injected components flowing in.

The mixer 8 first mixes the first component and air with one another along the mixing space 5, proceeding from the first end 3. Next, the mixer 8 mixes the mixture of the first component and air with the third component with one another.

Because the injection point 20c for the third component is set lower than the injection point 20b for air, air is already added to or mixed with the first component in the upper part of the mixing tube 2, without the first component already being mixed with the second component. This prevents clogging of the mixer 8.

The first end 3 of the mixing tube 2 can be closed and sealed in particular by a part of the mixer 8. Alternatively or additionally, a seal (not shown) can be provided for closing the first end 3.

The mixer 8 has a central piece 12. The central piece is configured substantially rotationally symmetrically and preferably has the smallest possible extent in the radial direction, in order to minimize centrifugal forces. The central piece 12 extends along the central axis 10 of the mixing tube 2. An axis of symmetry of the central piece 12 preferably coincides with the central axis 10 of the mixing tube 2. In addition, the axis of symmetry of the central piece 12 coincides with the axis of rotation of the mixer. For example, the central piece 12 is configured as a round or cylindrical rod.

In addition, the mixer 8 has a plurality of mixing elements 13. The mixing elements 13 serve for efficient mixing of the injected components. The mixing elements 13 are arranged on an outer side of the central piece 12, for example a lateral surface thereof. The mixing elements 13 extend in the radial direction of the central piece 12. The mixing elements 13 can be arranged distributed along the central piece 12 and/or with respect to the central axis 10 of the mixing tube 2. In addition, the plurality of mixing elements can be arranged distributed in the circumferential direction of the central piece.

For example, as shown, the mixing elements 13 are each configured as a lamella, which is arranged on the lateral surface of the central piece 12, wherein the mixing elements 13 each extend in the radial direction of the central piece 12. The mixing elements 13 can be arranged in a star shape and/or regularly around the central piece 12. However, the disclosure is not restricted thereto. The mixing elements 13 are preferably configured and/or arranged in such a way that no imbalance arises when the mixer 8 is rotated.

In addition, a plurality of mixing elements 16 are provided, which are arranged on the inner side of the wall 19 of the mixing tube 2 and extend counter to the radial direction towards the central axis 10 of the mixing tube 8 into the mixing space 5. As shown, the mixing elements 16 are likewise configured as lamellae. As shown, the mixing elements 16 are arranged only in the section 2a of the mixing tube 2, but the disclosure is not restricted thereto.

As shown in FIGS. 1A and 1B, the first injection unit 7a is arranged on the wall 19 in the first section 2a of the mixing tube 2. The first injection unit 7a is configured to inject the first component into a region of the mixing space 5 which adjoins the first section 2a of the mixing tube 2. In addition, the second injection unit 7b is arranged on the wall 19 in the first section 2a of the mixing tube 2. The second injection unit 7a is configured to inject the first component into a region of the mixing space 5 which adjoins the first section 2a of the mixing tube 2. The third injection unit 7c is arranged on the wall 19 in the second section 2b of the mixing tube 2. The third injection unit 7c is configured to inject the third component into a region of the mixing space 5 which adjoins the second section 2b of the mixing tube 2.

As shown in FIG. 2, the first injection unit 7a is arranged on the wall 19 in the first section 2a of the mixing tube 2. The second injection unit 7b is arranged on the wall 19 in the second section 2b of the mixing tube 2. The second injection unit 7c is arranged on the wall 19 in the third section 2c of the mixing tube 2.

The application device 1 further comprises a movement device 9. The movement device 9 can move the mixer 8 along and/or parallel to the central axis 10 of the mixing tube 2 and/or between the first end 3 and the second end 4, which is illustrated in the figures by a vertical double arrow. The movement device 9 is configured to move the mixer 8 upwards and downwards. The movement device 9 can be, for example, a lifting cylinder, in particular an electric lifting cylinder or electric-hydraulic lifting cylinder, or a linear unit with a coil.

The mixer 8 has a plurality of sections 8a, 8b, 8c along the central axis 10 of the mixing tube 8 or along the axis of symmetry of the central piece 12, wherein at least two of the sections 8a, 8b, 8c have mutually different outer diameters. The (maximum) extent of the mixer 8 in a plane which comprises the radial direction of the mixing tube 2 can be seen as the outer diameter of the mixer 8, wherein the mixing elements 13 are taken into account for the extent of the mixer 8.

As shown in FIGS. 1A and 1B, the mixer 8 has an outer diameter in a first section 8a which is greater than the outer diameter in a second section 8b. The first section 8a is arranged closer to the first end 3 than the second section 8b along the central axis 10 of the mixing tube 2.

As shown in FIG. 2, the mixer furthermore has a third section 8c which is arranged closer to the second end 4 of the mixing tube 2 than the second section 8b of the mixer along the central axis 10 of the mixing tube 2. The third section 8c has a larger outer diameter than the first section 8a and the second section 8b. The different outer diameters can be achieved in a simple manner by the mixing elements 13 extending differently far in the radial direction.

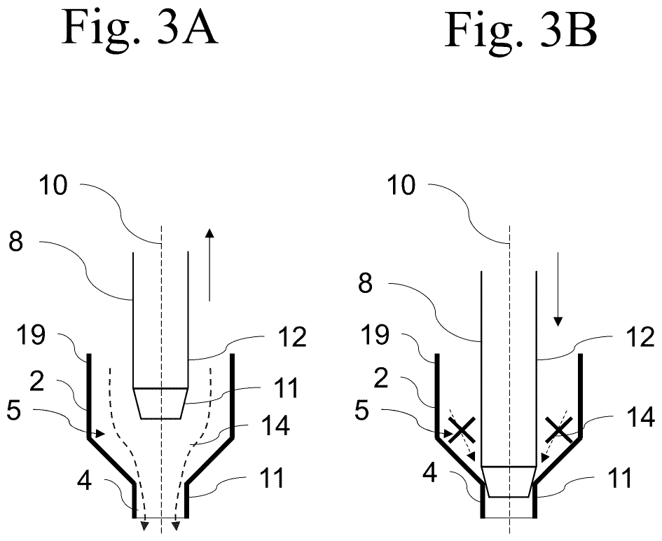

The movement of the mixer 8 is described with reference to FIGS. 3A to 5B. FIGS. 3B to 5A show schematic cross-sectional views of the second end 3 of the mixing tube 2 and the mixer 8 in different positions of an application device of various embodiments of the disclosure.

The mixer 8 can be moved along the mixing tube 2 between a first position and a second position. The second position can lie closer to the second end 3 than the first position along the mixing tube 2. On the other hand, the first position can lie closer to the first end 3 than the second position along the mixing tube 2.

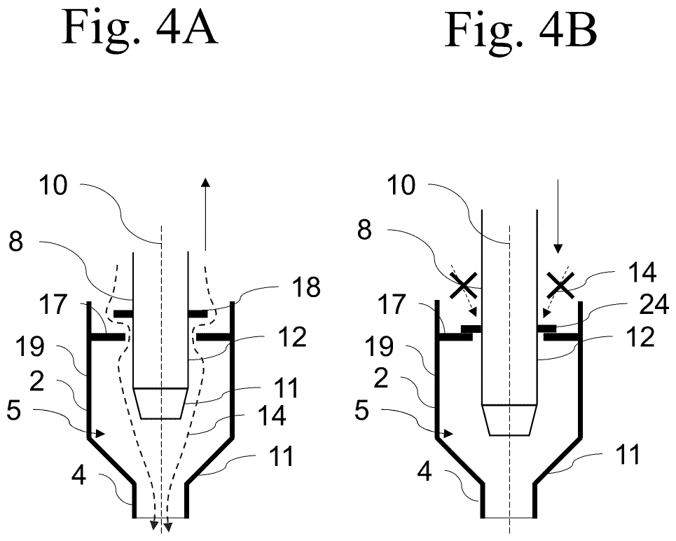

According to a first embodiment, the mixer 8 for producing the multicomponent mixture and for discharging the multicomponent mixture from the mixing tube 2 can be located in the first position. In order to close the second end 4 against unwanted leakage or dripping of the multicomponent mixture from the mixing tube 2, the mixer 8 can be located in the second position. For example, FIGS. 1A, 1B and 2, and also FIGS. 3A and 4A show the mixer 8 in the first position. In this position, a material flow 14 of the multicomponent mixture out of the mixing tube 2 via the second end 4 is made possible.

The mixer 8 can be moved from the first position in the direction of the second end 4 of the mixing tube 2 into the second position. For example, FIGS. 3B and 4B show the mixer 8 in the first position. This method has the effect that the mixing tube 2 is sealed with respect to a material flow 14 of the injected components and/or of the multicomponent mixture from the second end 4.

The mixing tube 2 can have at least one sealing element 17. The sealing element 17 is arranged in the region of the second end 4. The mixer 8 can likewise have a sealing element 18. A movement of the mixer 8 towards the second end 4 into the second position has the effect that a sealing element 18 of the mixer 8 comes into contact with the sealing element 17 of the mixing tube 2 and the mixing tube 2 is thereby sealed.

As shown in FIGS. 3A and 3B, the sealing element 17 is configured as a conical seat. Here, the sealing element 17 is formed by the second end 4 itself. An end 11 of the mixer 8 forms the sealing element 18, which is configured conically or as a truncated cone on its outer side. According to embodiments not shown, the mixer 8 can have a needle-shaped or pointed end 11. The second end 4 of the mixing tube 2 and the end 11 of the mixer 8 likewise form a needle valve.

As shown in FIGS. 4A and 4B, the sealing element 17 is configured as a ring, which extends from the inner side of the wall 19 of the mixing tube 2 in the radial direction towards the central axis 10. The sealing element 24 of the mixer 8 is likewise configured as a ring, which extends in the radial direction of the mixer 8 from a lateral surface of the central piece 12. In the radial direction, the sealing element 18 overlaps with the sealing element 17.

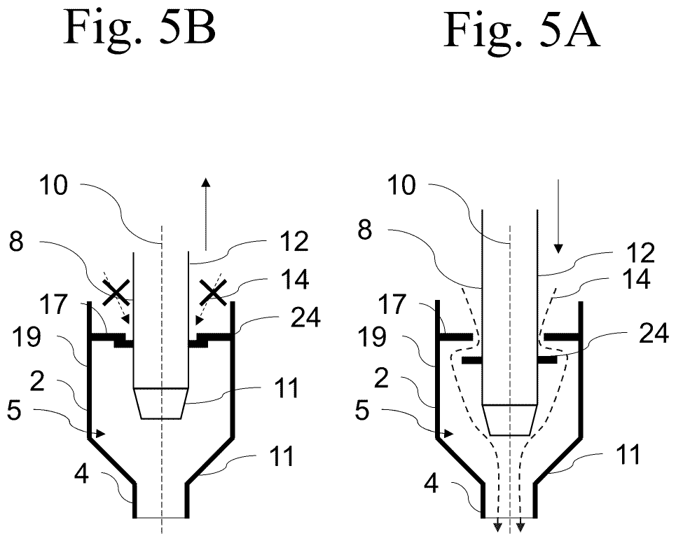

The embodiment of the application device shown in FIGS. 5A and 5B is constructed similarly to that in FIGS. 4A and 4B, with the following difference: the position of the sealing element 17 and of the sealing element 18 with respect to the second end 4 of the mixing tube 2 is reversed. The mixer 8 for producing the multicomponent mixture and for discharging the multicomponent mixture from the mixing tube 2 is thus located in the second position. In order to close the second end 4 against unwanted leakage of the multicomponent mixture from the mixing tube 2, the mixer 8 is located in the first position. For example, FIG. 5B shows the mixer 8 in the second position.

In this position, a material flow 14 of the multicomponent mixture out of the mixing tube 2 via the second end 4 is made possible.

The mixer 8 can be moved from the second position into the first position. For example, FIG. 5A shows the mixer 8 in the first position. This method causes the mixing tube 2 to be sealed against a material flow 14 of the injected components and/or the multi-component mixture from the second end 4.

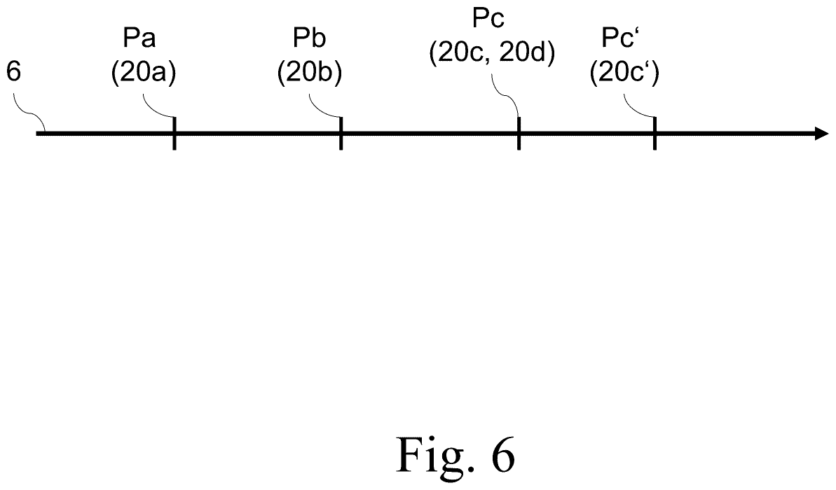

FIG. 6 shows a schematic view of a mixing section according to embodiments of the present disclosure.

As explained with reference to the preceding figures, the injection units 7a, 7b, 7c, 7d inject the corresponding components into the mixing space 5 via corresponding injection points 20a, 20b, 20c, 20c′, 20d. Along the mixing space 5, the mixer 8 mixes the corresponding components starting from the first end 3 of the mixing tube 2 towards the second end 4 of the mixing tube 2 in the order in which they are injected into the mixing space 5. The mixing space 5 accordingly defines a mixing section 6 starting from the first end 3 of the mixing tube 2 towards the second end 4 of the mixing tube 2. The mixing section 6 thus serves for the logical or abstract description of the injection order of the components into the mixing space 5, independently of the detailed geometry of the mixing tube 2 and/or of the mixer 5.

The mixing section 6 can be considered as an arrow or vector with the first end 3 as the origin and the second end 4 as the tip. The mixing section 6 can be considered as the course of the central axis 10 of the mixing tube starting from the first end 3 towards the second end 4. If the respective injection points 20a, 20b, 20c, 20c′, 20d are projected onto the central axis 10 of the mixing tube 2, corresponding positions Pa, Pb, Pc, Pc′ result along the mixing section 6, as illustrated in FIG. 6 for the embodiments of FIGS. 1A, 1B and 2.

If the injection points are located at different positions along the central axis 10, or at different heights on the wall 19 of the mixing tube, different positions result therefrom along the mixing section 6. This is the case, for example, for the injection points 20a, 20b, 20c, 20c′ or the positions Pa, Pb, Pc, Pc′. If, on the other hand, the injection points are located at the same position along the central axis 10, or at the same height on the wall 19 of the mixing tube, the same position results therefrom along the mixing section 6. This is the case, for example, for the injection points 20c, 20d and the position Pc. As shown in FIG. 1A, the injection points may be located at the same height along the tube wall 19, but at different positions along the circumference of the tube wall 19.

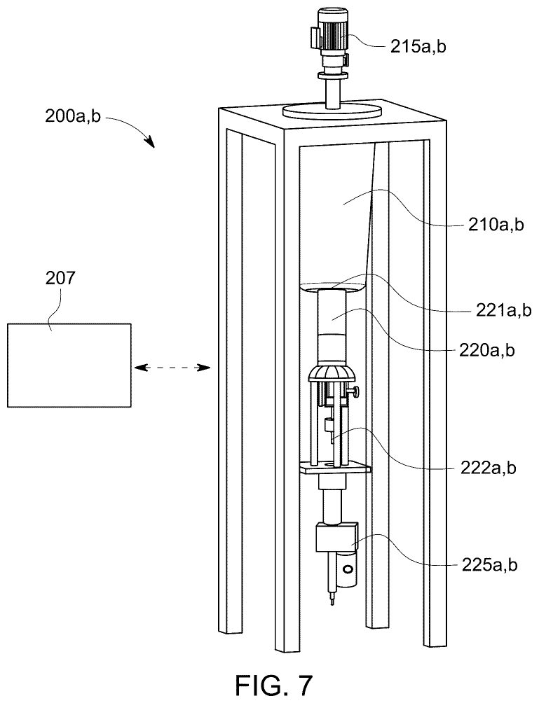

FIG. 7 shows an apparatus for material treatment 200 (also referred to herein as material treatment apparatus). In FIG. 1, the material treatment apparatus is denoted by the reference sign 200a, b, since a first apparatus 200a and a second apparatus 200b may be present. This is analogously valid for all elements of the material treatment apparatus. A material treatment apparatus 200 is described below, wherein the description may be valid for a first material treatment apparatus 200a and for a second material treatment apparatus 200b.

The material treatment apparatus 200 comprises a material container 210 and a pump apparatus 220. The material container 210 is configured to treat a material M. The material M may be one of the first, third, fourth and fifth components. In order to treat the material M, the material container 210 may be heatable. For this purpose, the material container 210 may comprise a heating apparatus (not shown in FIG. 1). The temperature in the material container 210 may be at least 10° C., preferably at least 30° C., above the ambient temperature of the material container 210. Alternatively or additionally, a pressure of less than 1.0 bar may prevail in the material container 210. In order to provide a negative pressure, the material container 210 may comprise a negative pressure unit. Alternatively or additionally, the material container 210 may be configured to stir or to move or to degas the material M. For this purpose, the material container 210 may comprise an agitator 11. The agitator 11 may be moved or driven by a drive 215.

The material M may be a liquid (at 20° C. and 1 bar). The material M may be a suspension. The material M may comprise a monomer for the polymerization of polyurethane. In particular, the material comprises a polyol or a polyisocyanate.

The material M may be stored by the material container 210 and pretreated in the material container 210. For example, the material M may be degassed in the material container 210 or adjusted to a defined physical and/or chemical state. As a result, the material may be metered accurately and reproducibly.

The pump apparatus 220 may be arranged downstream of the material container 210. The material M may flow directly or via additional elements, for example fluid guiding elements such as pipes or channels, into an inlet 221 of the pump apparatus 220. A pressure of less than 1.0 bar may prevail at the inlet 221 of the pump apparatus 220. In other words, the material M may have a vacuum at the inlet 221 of the pump apparatus 220.

The pressure of the material M may be increased by the pump apparatus 220. In particular, the pressure may be increased from the inlet 221 of the pump apparatus 220 to an outlet 22 of the pump apparatus 220, for example by at least 20 bar, at least 60 bar, at least 200 bar or even at least 300 bar. At the outlet 222 of the pump apparatus 220, the material M may be present at a pressure of at least 20 bar, at least 60 bar, at least 200 bar or even at least 300 bar.

The pump apparatus 220 may be a high-pressure pump. The pump apparatus 220 may be a piston pump. In particular, the pump apparatus 220 is a high-pressure piston pump.

A volume flow of the material (at the outlet 222 of the pump apparatus 220) may be regulated or controlled by the pump apparatus 220.

The material treatment apparatus 200 may comprise a drive 225 for the pump apparatus 220. The drive 225 may be a servo-hydraulic drive. The volume flow and/or mass flow of the material M may be regulatable or controllable by the drive 225.

The pump apparatus 220 may be electrically controllable or regulatable.

Material M may be treated in the material container 210 in the material treatment apparatus 200 and introduced into the pump apparatus 220. In the pump apparatus 220, the pressure of the material M may be increased so that the material may be discharged at the outlet 222 of the pump apparatus 220 at a pressure of at least 15 bar.

The material treatment apparatus 200 may be coupled to a control unit 207 or comprise the control unit 207. The control unit 207 may be coupled to the apparatus in a wired or wireless manner. The control unit 207 may be configured to control or regulate the material container 210 and/or the pump apparatus 220. In particular, the control unit 207 is configured to control or regulate the drive 215 of the agitator 211 and/or the drive 225 of the pump apparatus 220. The control unit may be the regulating unit 107 of FIG. 7.

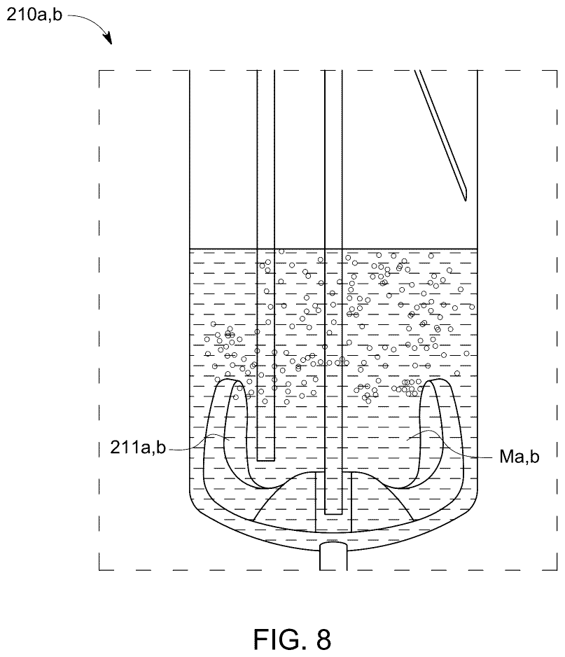

FIG. 8 shows a detailed view of the material container 210. Material M is contained or stored in the material container 210. The material M is treated in the material container 210. For example, a vacuum or a negative pressure for the material M may be provided by the material container 210. Alternatively or additionally, the material M may be heated in the material container 210. Alternatively or additionally, the material M may be stirred or moved in the material container 210, in particular by the agitator 211.

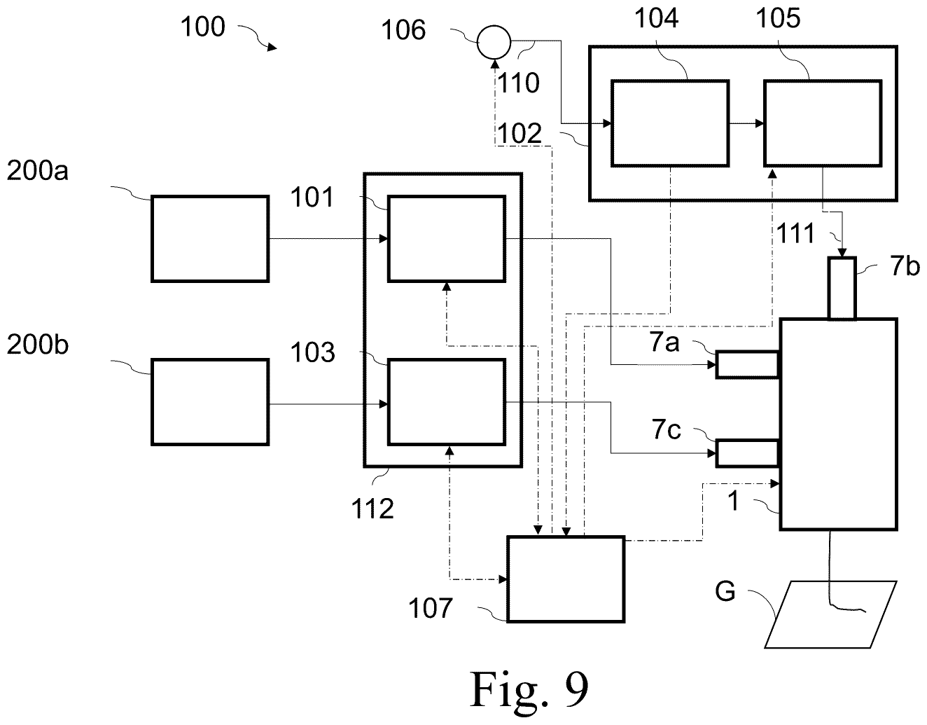

FIG. 9 shows a schematic view of an application system for mixing a plurality of components for producing a multicomponent mixture and for introducing or applying the multicomponent mixture into or onto an object according to embodiments of the present disclosure.

The application system 100 comprises an application device 1 according to embodiments of the present disclosure, for example the application device 1 of FIG. 1A.

Furthermore, the application system 100 may comprise at least one first material treatment apparatus 200a. The material treatment apparatus 200a is configured to provide a material flow of the first component. Furthermore, the application system 100 may comprise a second material treatment apparatus 200b. The second material treatment apparatus 200b is configured to provide a material flow of the third component.

The material treatment apparatus 200a may comprise a first material container 210a and a first pump apparatus 220a. The first material container 210a may be configured to treat the first component (corresponds to material Ma in FIG. 8). The first pump apparatus 220a may have a first inlet 221a and a first outlet 222a. The first inlet 221a of the first pump apparatus 220a may be connected in a fluid-communicating manner to the first material container 210a so that the first material Ma may be introduced from the first material container 210a into the first pump apparatus 20a. The first pump apparatus 220a may be configured to provide the first material Ma at the first outlet 222a of the first pump apparatus 220a at a pressure of at least 15 bar.

The application system 100 may comprise a second material treatment apparatus 200b. The second material treatment apparatus 200b may comprise a second material container 210b and a second pump apparatus 220b. The second material container 210b may be configured to treat the third component (corresponds to material Mb in FIG. 8). The second pump apparatus 220b may have a second inlet 221b and a second outlet 222b. The second inlet 221b of the second pump apparatus 220b may be connected in a fluid-communicating manner to the second material container 210b so that the second material Mb may be introduced from the second material container 210b into the second pump apparatus 220b. The second pump apparatus 220b may be configured to provide the second material Mb at the second outlet 222b of the second pump apparatus 220b at a pressure of at least 15 bar.

The application apparatus 1 may be connected in a fluid-communicating manner to the first outlet 222a and the second outlet 222b so that the first component and the third component may be introduced into the application apparatus 1.

Furthermore, the application system 100 comprises a first metering apparatus 101 which is configured to receive the material flow of the first component from the material treatment apparatus 200a, to set a mass flow and/or volume flow of this component and to provide the material flow to the first injection unit 7a of the application apparatus 1.

In addition, the application system 100 comprises a second metering apparatus 102 which is configured to receive a material flow of the second component, to set a mass flow and/or volume flow of the second component and to provide the material flow to the second injection unit 7b of the application apparatus 1. For example, the second component is gas or a gas mixture, for example air, and the material flow is a gas flow or air flow.

Furthermore, the application system comprises a third metering apparatus 103 which is configured to receive the material flow of the third component from the second material treatment apparatus 200b, to set a volume flow of these components and to provide the material flow to the third injection unit 7c of the application apparatus 1.

The first metering apparatus 101 and the third metering apparatus 103 may preferably be contained in a metering device 112 or form the metering device 112. The first metering apparatus 101 and the third metering apparatus 103 may be of identical design or have identical functions. The metering device 112 may be, for example, a tandem meterer DPL 2001 2KT from Scheugenpflug.

Each of the metering apparatuses may also be configured to set a volume flow of the corresponding components. According to embodiments which are not shown, the application system 100 may comprise further corresponding apparatuses for material treatment and metering apparatuses for further components, such as a fourth and/or fifth component.

The second metering apparatus 102 comprises a measuring unit 104, for example an air mass sensor or an air quantity sensor. The second metering apparatus 102 further comprises an actuator 105, in particular an air valve, for example a proportional air valve. The measuring unit 104 is configured to receive the air flow from an air supply device 106 of the application system 100 or from an external air supply device 106 and to measure a mass flow and/or a volume flow of the air flow and to provide the air flow to the actuator 105. The actuator 105 is configured to receive the air flow from the measuring unit 104, to set the mass flow and/or the volume flow of the air flow and to provide the air flow to the second injection unit 7b. With a proportional air valve, a variable volume flow and/or mass flow of the air flow may be provided.

The air supply device 106 may be, for example, an air pump. The air supply device 106 is configured to provide the air flow at a predetermined pressure.

The application system 100 further comprises a first line 110 between the air supply device 106 and the second metering apparatus 102 and a second line 111 between the second metering apparatus 102 and the second injection unit 7a. The lines 110, 111 may be, for example, hoses. The lines 110, 111 serve for guiding the air flow between the air supply device 106, the second metering apparatus 102 and the second injection unit 7a. The second component thus flows in a material flow direction from the air supply device 106 to the metering apparatus 102 to the injection unit 7b.

The application system 100 further comprises measuring units for measuring a pressure. The application system 100 comprises a first line pressure sensor (not shown) which is configured to measure an air pressure in the first line 110. The application system 100 further comprises a second line pressure sensor (not shown) which is configured to measure an air pressure in the second line 111.

The application system 100 further comprises corresponding fluid guiding elements or lines for conveying the first component from the first material treatment apparatus to the first metering apparatus 101 and to the first injection unit 7a and also lines for conveying the second component from the second material treatment apparatus 200b to the third metering apparatus 103 and to the third injection unit 7b. The first component thus flows in a material flow direction from the first material treatment apparatus 200a to the metering apparatus 101 and subsequently to the injection unit 7a. In addition, the third component flows in a material flow direction from the second material treatment apparatus 200b to the metering apparatus 103 and subsequently to the injection unit 7b.

The first material treatment apparatus 200a, the first metering apparatus 101 and the first injection unit 7a are connected to one another in a fluid-communicating manner. The second material treatment apparatus 200b, the third metering apparatus 103 and the third injection unit 7c are connected to one another in a fluid-communicating manner. The air supply device 106, the second metering apparatus 102 and the second injection unit 7b are connected to one another in a fluid-communicating manner.

The lines and the material flow of the first component, the second component and the third component are illustrated in FIG. 9 by means of solid arrows.

The application system 100 is configured to mix the first component and the third component with air only in the mixing space 5 of the application apparatus 1. The application system 100 mixes neither the first component nor the third component with air beforehand. In particular, the application system does not mix the first component or the third component with air already in the corresponding material treatment apparatus 200a, 200b or upstream of the corresponding metering apparatus 101, 103. The first component is thus not mixed with air upstream of or in the injection unit 7a in a material flow direction from the first material treatment apparatus 200a to the metering apparatus 101 to the injection unit 7a. Correspondingly, the third component is not mixed with air upstream of the injection unit 7b in a material flow direction from the material treatment apparatus 200b to the metering apparatus 103 to the injection unit 7b. The first component and the third component are thus not mixed with gas or air upstream of the application apparatus 1 and not upstream of the corresponding injection units 7a, 7b.

The application system is thus configured to mix the first component with air upstream of the first metering apparatus 101 and upstream of the first injection unit 7a in a material flow direction of the first component. The application system is configured to mix the third component with air upstream of the third metering apparatus 103 and upstream of the third injection unit 7b in a material flow direction of the third component. The first component and the third component are thus injected into the mixing space 5 in an air-free or gas-free state.

The application system further comprises a regulating unit 107. The regulating unit 107 comprises, for example, a computing unit, in particular a microprocessor. The regulating unit 107 is configured to control and/or regulate an operation of the application system 100. For this purpose, the regulating unit 107 is configured to receive measured values or measurement signals from measuring units of the application system, for example the measuring unit 104, the first to third pressure sensors for the mixing space 5 and the line pressure sensors. In addition, the regulating unit 107 is configured to actuate the metering apparatuses 101, 102, 103, the injection units 7a, 7b, 7c, the actuator 105, the air supply device 106, the material treatment apparatuses 200a, 200b. The reception of measured values and the actuation of the respective units is illustrated in FIG. 9 by dashed single and double arrows.

The system 100 may also be referred to as a system for the application of a mixture, in particular for the polymerization of polyurethane.

The regulating unit 107 is configured to carry out a regulating step of a method according to embodiments of the present disclosure.

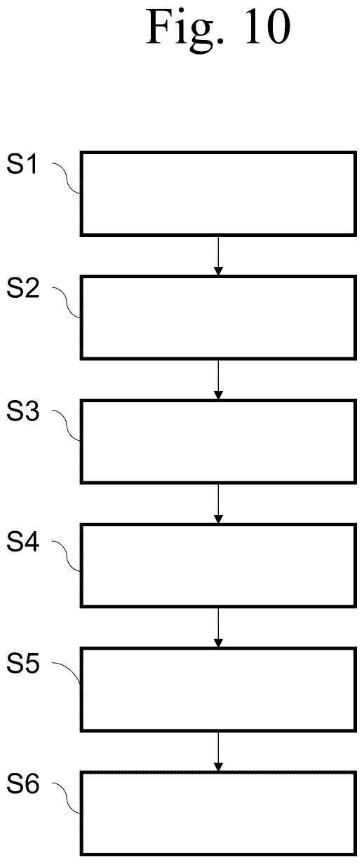

FIG. 10 shows a flow diagram of a method for mixing a plurality of components for producing a multicomponent mixture and for introducing or applying the multicomponent mixture into or onto an object according to embodiments of the present disclosure. The method may be carried out by means of an application device or an application system according to embodiments of the present disclosure, for example the application device of FIG. 1A and the application system of FIG. 9. The method comprises the following steps. The steps are carried out simultaneously.

A first component is injected by means of a first injection unit into a mixing space 5 of a mixing tube having a first end and a second end, S1. Here, the mixing space defines a mixing section. The first component is injected into the mixing space at a first injection point. The first component is thus injected into the mixing space at a first position corresponding to this first injection point along the mixing section.

A second component, for example gas or a gas mixture, in particular air, is injected into the mixing space by means of a second injection unit, S2. The second component is injected into the mixing space at a second injection point. The second component is injected into the mixing space at a corresponding second position along the mixing section. Here, the second position is arranged behind the first position along the mixing section.

The method comprises the injection, S4, of a third component into the mixing space by means of a third injection unit. The third component is injected into the mixing space at a third injection point. The third component is injected into the mixing space at a corresponding third position along the mixing section. Here, the third position is arranged behind the second position P along the mixing section.

The method comprises the mixing of the first to third components along the mixing tube based on the order in which the components were injected along the mixing section. The mixing is carried out by means of a mixer arranged in the mixing space. The mixing comprises the mixing, S3, of the first component with the second component. The method comprises the mixing, S5, of the mixture of the first component and the second component with the third component for producing the multicomponent mixture comprising the first, second and third components.

The method further comprises the discharging, S6, of the multicomponent mixture from the mixing tube through the second end. The method further comprises the application of the multicomponent mixture onto the object.

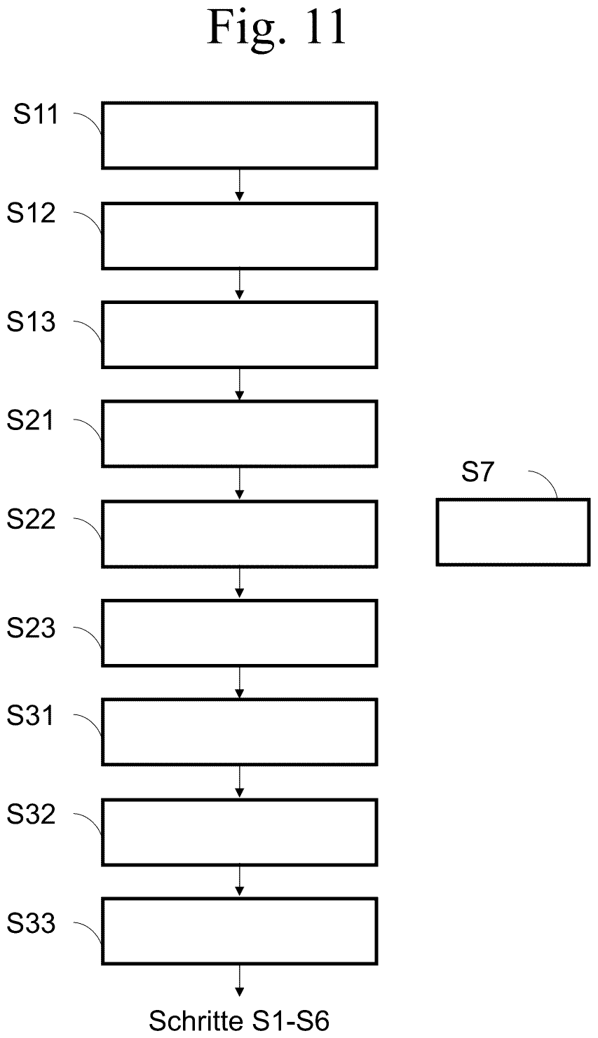

FIG. 11 shows a flow diagram of a method for mixing a plurality of components for producing a multicomponent mixture and for introducing or applying the multicomponent mixture into or onto an object according to further embodiments of the present disclosure. The method may be carried out by means of an application system according to embodiments of the present disclosure, for example the application system of FIG. 9. The method comprises the following steps. The steps are carried out simultaneously.

A material flow of a first component is provided by means of a first apparatus for material treatment to a first metering apparatus, S11. By means of the first metering apparatus, a mass flow and/or volume flow of the first component is set, S12, and the material flow is provided to a first injection unit, S13.

An air flow is provided by means of an air supply device to a second metering apparatus, S21. By means of the second metering apparatus, a mass flow and/or volume flow of the air flow is set, S22, and the air flow is provided to a second injection unit, S23.

A material flow of a third component is provided by means of a second apparatus for material treatment to a third metering apparatus, S31. By means of the third metering apparatus, a mass flow and/or volume flow of the third component is set, S32, and the material flow is provided to a third injection unit of the application apparatus, S33.

The method of FIG. 11 further comprises the method with the steps S1-S6 of FIG. 10. The method further comprises regulating, S7, by means of a regulating unit.

The regulating may comprise actuating a rotary apparatus for the mixer and/or the first metering apparatus and/or the second metering apparatus, in particular a measuring unit and an actuator, and/or the third metering apparatus and/or the air supply device.

The regulating may comprise regulating an air pressure, in particular in a line for guiding the air flow and/or at the second injection point for the air, in such a way that the second component is injected into the mixing space at a higher pressure than the first component and/or than the third component, or that the air pressure is higher than a pressure in the mixing space. Preferably, the difference may be 1 bar or more. The air pressure may be adjusted, for example, by adjusting an air pressure by means of the air supply device and/or by means of the actuator of the second metering apparatus.

The regulating may further comprise regulating the ratio of the mass flow of the air flow to the mass flow of the first component and/or regulating or adjusting the ratio of the mass flow of the air flow to the mass flow of the third component. Here, these may preferably be the mass flows of the material flows of the components injected into the mixing space.

A setpoint value for the ratio may be predetermined by the regulating unit or by an external system or a user of the application device. The setpoint value may be predetermined by a mathematical function. This ensures that the same amount of air is always added to the material of the first component and to the material of the third component. In other words, it is ensured that the same predetermined amount of air is always added to the PU foam. The ratio may be adjusted, for example, by: adjusting the mass flow of the first component by means of the first metering apparatus and/or adjusting the mass flow of the third component by means of the third metering apparatus and/or adjusting the mass flow and/or volume flow of the air by means of the second metering apparatus, and/or adjusting the rotational speed of the mixer by means of a rotary apparatus of the mixer, and/or adjusting an air pressure by means of the air supply device.

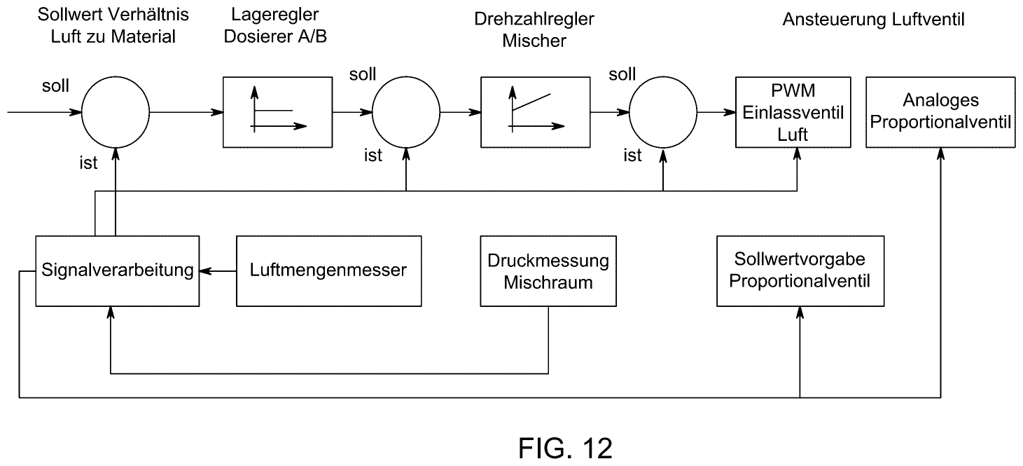

FIG. 12 shows a diagram for illustrating a regulating step of a method for mixing a plurality of components for producing a multicomponent mixture and for introducing or applying the multicomponent mixture into or onto an object according to embodiments of the present disclosure.

An air quantity meter as measuring unit measures a quantity or a mass flow of the air injected into the mixer. In addition, a pressure in the mixing space is measured via a pressure sensor. Based thereon, signal processing is carried out, for example, by means of the regulating unit. Based on the signal processing, actual values for the “air-to-material ratio”, an actual value for a position regulator of the first metering apparatus for the first component and/or a position regulator of the third metering apparatus for the third component, an actual value for the rotational speed of the mixer, and an actual value for a PWM control of the inlet valves of the second injection unit for the air flow are predetermined. In addition, based on the signal processing, a setpoint value for the proportional valve of the second metering apparatus for the air flow is predetermined. The proportional valve may be analogous.

The “air-to-material ratio” describes, for example, a ratio of the injected amount of air or of an injected mass flow of the air to the injected quantity of the first component (A in FIG. 12) or to the injected mass flows of the first component into the mixing space.

A setpoint value for the position regulator of the first or third metering apparatus results from the setpoint value for the “air-to-material ratio”. A setpoint value for the rotational speed of the mixer further results from the setpoint value for the “air-to-material ratio”. A setpoint value for the actuation of the inlet valves further results from the setpoint value for the “air-to-material ratio”.

Based on the setpoint value and the actual value for the “air-to-material ratio”, the position of the first or third metering apparatus is regulated. The position can describe, for example, an opening angle of a metering unit of the metering apparatus. However, the position can also be set as a function of a desired quantity or a desired material flow of the PU foam.

The rotational speed of the mixer is regulated based on the setpoint value and the actual value for the rotational speed. For example, the rotational speed is regulated proportionally to a difference between the setpoint value and the actual value.

Furthermore, the inlet valve is actuated based on the setpoint value and the actual value for the PWM control of the inlet valves.

In addition, the proportional valve is actuated.

The air supply is regulated proportionally to the material flow and the mixer rotational speed so that it is ensured that the same amount of air is always added to the material. The amount of air is determined via the proportional valve. An air flow meter is used as a measuring instrument. The supplied air pressure should always be at least 1 bar higher than the pressure in the mixing chamber. It can thus be prevented that the material of the first component or material of the third components flows into the injection unit and/or the lines for the air flow and clogs or contaminates them. According to embodiments, the amount of air is regulated via the air flow meter. The proportional valve regulates the air pressure.

### REFERENCE SIGNS LIST

1 Application device
2 Mixing tube
2a, 2b, 2c Sections of the mixing tube
2d, 2e Transition sections of the mixing tube
3 First end of the mixing tube
4 Second end of the mixing tube
5 Mixing space
6 Mixing section
7a, 7b, 7c Injection units
8 Mixer
8a, 8b, 8c Sections of the mixer
9 Moving device
10 Central axis of the mixing tube
11 End of the mixer
12 Central piece of the mixer
13 Mixing elements of the mixer
14 Material flow
15 Rotary apparatus
16 Mixing elements of the application device
17 Sealing element of the mixing tube
18 Sealing element of the mixer
19 Wall of the mixing tube
20, 20b, 20c, 20c′, 20d Injection points
100 Application system
101 First metering apparatus
102 Second metering apparatus
103 Third metering apparatus
104 Measuring unit
105 Actuator
106 Air supply device
110 First line
111 Second line
112 Metering device
200a,b Apparatus for material treatment
207 Control apparatus
210a,b Material container
211a,b Agitator
215a,b Drive
220a,b Pump apparatus
221a,b Inlet
222a,b Outlet
225a,b Drive

What is claimed is:

1. Application apparatus for mixing a plurality of components for producing a multicomponent mixture, in particular a polyurethane foam, and for introducing and/or applying the multicomponent mixture into and/or onto an object, in particular a lithium-ion battery, comprising:
a mixing tube having a first closed end and a second end for discharging the multicomponent mixture from the mixing tube, wherein the mixing tube has a mixing space between the first end and the second end,
a plurality of injection units arranged on the mixing tube, each configured to inject a corresponding one of the plurality of components into the mixing space,
a mixer arranged at least partially in the mixing space, configured to mix the injected components with one another along the mixing tube, and
a moving device configured to move the mixer along a central axis of the mixing tube and/or between the first end and the second end.

2. Application device according to claim 1, wherein
a movement of the mixer in the direction of the second end causes the mixing tube to be sealed against a material flow of the injected components and/or the multicomponent mixture from the second end and/or towards the second end, and/or
a movement of the mixer in a direction away from the second end causes the mixing tube to be sealed against a material flow of the injected components and/or the multicomponent mixture from the second end and/or towards the second end.

3. Application device according to claim 2, wherein the mixing tube has at least one sealing element, wherein the sealing element is arranged in the region of the second end or at the second end of the mixing tube, and/or is formed by the second end of the mixing tube.

4. Application device according to claim 3, wherein a movement of the mixer towards the second end or a movement away from the second end causes the mixer to come into contact with the sealing element and the mixing tube to be sealed thereby.

5. Application device according to claim 3, wherein the sealing element is formed as a ring or cone, and/or
wherein the mixer has a spherical, conical, conical, frustoconical, needle-shaped or pointed end which lies opposite the second end of the mixing tube, and/or
wherein the sealing element and the end of the mixer form a needle valve.

6. Application device according claim 1, further comprising:
a rotary apparatus (18), preferably an electric motor, particularly preferably a servo electric motor, configured to rotate the mixer about an axis of rotation parallel to the central axis of the mixing tube, wherein the central axis of the mixing tube and the axis of rotation of the mixer preferably coincide.

7. Application device according to claim 1, wherein the mixer has a plurality of sections along the central axis of the mixing tube, wherein at least two of the plurality of sections have mutually different outer diameters.

8. Application device according to claim 7, wherein the plurality of sections comprise a first section (and a second section, wherein the first section has a larger outer diameter than the second section, and wherein the first section is arranged closer to the first end than the second section and/or wherein the first section is arranged above the second section.

9. Application device according to claim 8, wherein the plurality of sections further comprise at least one third section, which is arranged closer to the second end of the mixing tube than the second section of the mixer, and wherein the at least one third section has a different, preferably larger, outer diameter than the second section.

10. Application device according to claim 9, wherein the mixing tube has a plurality of sections along the central axis, wherein a wall of the mixing tube of at least two of the plurality of sections has mutually different inner diameters.

11. Application device according to claim 10, the plurality of sections comprising:
a first section and a second section, wherein the wall of the mixing tube has a larger inner diameter in the first section than in the second section, and wherein the first section is arranged closer to the first end of the mixing tube than the second section and/or wherein the first section is arranged above the second section,
preferably a third section, wherein the wall of the mixing tube has a different inner diameter in the third section than in the second section, and wherein the third section is arranged closer to the second end of the mixing tube than the second section.

12. Application device according to claim 11,
wherein at least one first injection unit is arranged on a wall of the mixing tube in the first section, configured to inject a first component into a region of the mixing space adjacent to the first section of the mixing tube, and/or
wherein at least one second injection unit is arranged on a wall of the mixing tube in the second section of the mixing tube, configured to inject a second component into a region of the mixing space adjacent to the second section of the mixing tube, and/or
wherein at least one third injection unit (7c) is arranged on a wall of the mixing tube in the third section of the mixing tube, configured to inject a third component into a region of the mixing space adjacent to the third section (2c) of the mixing tube.

13. Application device according to claim 12, further comprising:
a first pressure sensor configured to measure a pressure in the mixing space adjacent to the first section of the mixing tube, and/or
a second pressure sensor configured to measure a pressure in the mixing space adjacent to the second section of the mixing tube, and/or
a third pressure sensor configured to measure a pressure in the mixing space adjacent to the second end of the mixing tube and/or adjacent to the third section of the mixing tube.

14. Application device according to claim 1, wherein the mixer has a central piece, which is formed in a rod-shaped manner, and/or which is formed in a rotationally symmetrical manner.

15. Application device according to claim 1, wherein the mixer has at least one mixing element, which is arranged on a lateral surface of the central piece and/or extends in a radial direction of the central piece.

16. Application device according to claim 15, wherein the at least one mixing element is formed as a lamella, tine, hook or rod, and/or wherein the at least one mixing element is formed as a ring surrounding the central piece, and/or wherein the at least one mixing element is formed as a thread or as a helix or comprises the latter.

17. Application device according to claim 1, further comprising at least one mixing element, which is arranged on a wall of the mixing tube and extends into the mixing space, wherein the at least one mixing element is formed as a ring, or wherein the at least one mixing element is formed as a lamella, tine, hook or rod, or wherein the at least one mixing element is formed as a regular or irregular structure.

18. Application device according to claim 1, wherein the mixing tube is formed in a straight manner and/or wherein the mixing tube is oriented vertically, wherein the first end is arranged above the second end, and/or
wherein the inner side of the wall of the mixing tube is rotationally symmetrical about the central axis.

19. Application device according to claim 1, wherein the moving device is formed as a lifting cylinder, in particular as an electric lifting cylinder or electro-hydraulic lifting cylinder, or comprises the latter.

20. Application system for mixing a plurality of components for producing a multicomponent mixture and for introducing and/or applying the multicomponent mixture into and/or onto an object, comprising:
an application device according to claim 1;
a first apparatus for material treatment, configured to provide a material flow of the first component,
a second apparatus for material treatment according to claim 1, configured to provide a material flow of a third component,
a first metering apparatus configured to receive the material flow of the first component, to set a mass flow and/or volume flow of the first component and to provide the material flow to the first injection unit of the application apparatus;
a second metering apparatus configured to receive a material flow of the second component, to set a mass flow and/or volume flow of the second component and to provide the material flow to the second injection unit of the application apparatus;
a third metering apparatus configured to receive a material flow of the third component, to set a mass flow and/or volume flow of the third component and to provide the material flow to the third injection unit of the application apparatus.
